(19) United States
(12) Patent Application Publication
(10) Pub. No.: US 2025/0145515 A1
(43) Pub. Date: May 8, 2025

(54) LOW LITHIUM, LOW THERMAL EXPANSION HIGH RECYCLED CONTENT GLASSES

(71) Applicant: CORNING INCORPORATED, CORNING, NY (US)

(72) Inventors: Jaymin Amin, Corning, NY (US); Carol Ann Click, Corning, NY (US); Timothy Michael Gross, Painted Post, NY (US); Kristy Lynn Smith, Bath, NY (US); Jingshi Wu, Painted Post, NY (US)

(21) Appl. No.: 18/928,625

(22) Filed: Oct. 28, 2024

Related U.S. Application Data
(60) Provisional application No. 63/547,195, filed on Nov. 3, 2023.

(51) Int. Cl. C03C 3/091; C03C 1/00; C03C 3/118; C03C 21/00

(52) U.S. Cl. CPC C03C 3/091; C03C 1/002; C03C 3/118; C03C 21/002

(57) ABSTRACT

A glass comprising a coefficient of thermal expansion (CTE) of 70×10⁻⁷/° C. or less, a liquidus viscosity of at least 150 kP, and Li₂O in an amount of 0.1 wt. % or less, wherein the glass is ion-exchangeable. A glass, comprising SiO₂ in an amount of 64-73 wt. %, Al₂O₃ in an amount of 7-15 wt. %, B₂O₃ in an amount of 9-11 wt. %, Na₂O in an amount of 6-9.5 wt. %, K₂O in an amount of 0.5-3 wt. %, CaO in an amount of at least 0.05 wt. %, and Li₂O in an amount of less than 0.1 wt. %, wherein a weight ratio of Na₂O/Al₂O₃ is less than or equal to 0.9. A method of recycling glass, the method comprising heating a composition to form a melt, the composition comprising glass cullet in an amount of at least 60 wt. %, and raw materials in an amount of 40 wt. % or less.

### CROSS-REFERENCE TO RELATED APPLICATIONS

This application claims the benefit of priority to U.S. Provisional Patent Application No. 63/547,195 filed on Nov. 3, 2023, the content of which is incorporated herein by reference in its entirety for all purposes.

### FIELD

The disclosure relates generally to glasses made from recycled glass as a component, and more particularly to compositions and methods for making such glasses.

### BACKGROUND

Glass waste, encompassing not only post-consumer glass but also unused inventory and excess glass from manufacturing processes, represents an untapped opportunity for innovative and beneficial uses. While standard recycling of glass waste contributes to environmental sustainability, such recycling may result in lower economic value downcycled products, or recycling may not even occur and the glass waste may be disposed in landfills.

Therefore, there is a need in the art for compositions and glasses that incorporate glass waste, as well as recycling methods thereof. This disclosure is directed to these, as well as other, important ends.

### SUMMARY

The disclosure relates, in various aspects, to a glass, comprising:
a coefficient of thermal expansion (CTE) of 70×10⁻⁷/° C. or less;
a liquidus viscosity of at least 150 kP; and
Li₂O in an amount of 0.1 wt. % or less;
wherein the glass is ion-exchangeable.

The disclosure relates, in various aspects, to a glass comprising:
SiO₂ in an amount of 64-73 wt. %;
Al₂O₃ in an amount of 7-15 wt. %;
B₂O₃ in an amount of 9-11 wt. %;
Na₂O in an amount of 6-9.5 wt. %;
K₂O in an amount of 0.5-3 wt. %;
CaO in an amount of at least 0.05 wt. %; and
Li₂O in an amount of 0.1 wt. % or less;
wherein a weight ratio of Na₂O/Al₂O₃ is less than or equal to 0.9.

The disclosure relates, in various aspects, to a method of chemically strengthening a glass-based substrate, the method comprising:
ion exchanging the glass-based substrate in a molten salt bath to form a glass-based article;
wherein the glass-based article comprises:
   a maximum compressive stress (CS) of 300-600 MPa; and
   a depth of layer (DOL) of 5-30 μm;
wherein the glass-based substrate comprises the glass disclosed elsewhere herein.

The disclosure relates, in various aspects, to a glass-based article, comprising:
a maximum compressive stress (CS) of 300-600 MPa;
a depth of layer (DOL) of 5-30 μm; and
a composition at a center of the glass-based article;
wherein the composition at the center of the glass-based article comprises the glass disclosed elsewhere herein.

The disclosure relates, in various aspects, to a consumer electronic device comprising:
a housing having a front surface, a back surface, and side surface;
electrical components provided at least partially within the housing, the electrical components including at least a controller, a memory, and a display, the display being provided at or adjacent to a front surface of the housing; and
a cover glass disposed over the display,
wherein at least one of a portion of the housing or the cover glass comprises the glass or glass-based article disclosed elsewhere herein.

The disclosure relates, in various aspects, to a method of recycling glass, the method comprising:
heating a composition to form a melt, the composition comprising:
   glass cullet in an amount of at least 60 wt. %; and
   raw materials in an amount of 40 wt. % or less;
   based on total weight of the composition;
wherein, when the melt is formed and cooled to form a glass-based substrate, the glass-based substrate is the glass disclosed elsewhere herein.

The disclosure relates, in various aspects, to a composition, comprising:
glass cullet in an amount of at least 60 wt. %; and
raw materials in an amount of 40 wt. % or less;
based on total weight of the composition
wherein the glass cullet comprises:
   SiO₂ in an amount of 65-80 wt. %;
   Al₂O₃ in an amount of 1-10 wt. %;
   B₂O₃ in an amount of 5-15 wt. %;
   Na₂O in an amount of 1-10 wt. %;
   K₂O in an amount of 0.1-5;
   CaO in an amount of 0.05-10 wt. %; and
   Li₂O in an amount of less than 0.1 wt. %;
   based on total weight of glass cullet; and
wherein the raw materials comprise at least one of:
   SiO₂;
   Na₂CO₃; and
   Al₂O₃.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 schematically depicts a cross section of a glass-based article having compressive stress regions according to aspects described and disclosed herein.

FIG. 2A is a plan view of an exemplary electronic device incorporating any of the glass-based articles disclosed herein.

FIG. 2B is a perspective view of the exemplary electronic device of FIG. 2A.

FIG. 3 is a line graph showing the relationship between glass viscosity (e.g., 35 kP temperature) and the Na₂O/Al₂O₃ weight ratio, in accordance with some aspects of the disclosure.

FIG. 4 is a line graph showing the relationship between maximum compressive stress (CS) and the amount of Na₂O, in accordance with some aspects of the disclosure.

FIG. 5 is a line graph showing the relationship between depth of layer (DOL) and the Na₂O/Al₂O₃ weight ratio, in accordance with some aspects of the disclosure.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

If the term “about” is used in describing a value or an end-point of a range, the disclosure should be understood to include the specific value or end-point referred to. As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. It is noted that the terms “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass that is “substantially free” of any specific component (e.g., Al₂O₃, MgO, or any other component) is one in which the component is not actively added or batched into the glass, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the glass (moles or mass for ppm, and mass for wt. %).

Herein, glass compositions, including the compositions of glass cullet, are expressed in terms of wt. % amounts of particular components included therein on an oxide bases unless otherwise indicated. Any component having more than one oxidation state may be present in a glass composition in any oxidation state. However, concentrations of such component are expressed in terms of the oxide in which such component is at its lowest oxidation state unless otherwise indicated.

As used herein, “glass cullet” means a glass that is in a size-reduced form, such as in the form of crushed, ground, exploded, imploded, glass chunks or particles. Glass cullet is generally used herein as a component to make a glass (e.g., such as a glass containing glass cullet as a recycled component). In this regard, the glass cullet generally is used in combination with one or more raw materials to make the glass. Glass cullet can include glass that is waste glass and/or excess glass produced when making glass articles (e.g., displays, vials, tubes, tubing, pipettes, etc.), or glass cullet can include final glass articles that are broken or otherwise not needed any longer (e.g., because there is an excess of stock that will not be sold into a market, and/or post-consumer glass). Glass cullet may be glass that otherwise would end up in a landfill, but is being repurposed by remelting in combination with one or more raw materials to form another glass.

As used herein, “raw materials” are certain starting materials that, when combined and melted in an appropriate manner, produce a glass as in a typical glass manufacturing process. In this way, “raw materials” are different from, and are to be distinguished from, glass, such as glass cullet. Raw materials can include, for example, silica, alumina, sodium carbonate, and so forth. Herein, the raw materials are combined with glass cullet to form a new glass (e.g., a glass containing glass cullet as a recycled component).

As used herein, the term “ion-exchangeable” means that a glass has a composition such that it is capable of undergoing chemical strengthening by way of ion exchange. For example, a glass having an appropriate structure and containing lithium can undergo ion exchange in a molten salt bath containing sodium and/or potassium so as to replace a portion of the lithium with sodium and/or potassium. Similarly, a glass having an appropriate structure and containing sodium can undergo ion exchange in a molten salt bath containing potassium so as to replace a portion of the sodium with potassium. As is known in the art, replacing smaller alkali ions in glass with larger alkali ions results in a compressive stress in the glass, thereby strengthening the glass. An “appropriate structure” in the glass is one that allows such ion exchange to take place so as to result in a compressive stress and associated strengthening of the glass.

The terms “glass.” “glass composition,” and “glass-based substrate” generally are used interchangeably herein. In addition, the terms “glass article” and “glass-based article” generally are used interchangeably herein. However, in each case there may be different meanings intended as will be clear from context. For example, the term “glass composition” may be used when referring to the composition of a glass (e.g., glass cullet) or glass article (or center thereof), or to the composition of a glass (e.g., glass cullet) that is melted along with raw materials to form a glass. Additionally, for example, the terms “glass article” and “glass-based article” may be used interchangeably to refer to an ion-exchanged glass, and a “glass” or “glass-based substrate” can be used to refer to the glass that is subjected to IOX. Again, while these terms may be used interchangeably herein in some aspects, sometimes different meanings are intended, and such meanings will be clear from context.

All compositional amounts herein are in weight percent (wt. %) unless otherwise specified.

All glass viscosities herein (e.g., the temperatures according to 200 P, 35,000 P, 100,000 P, and 200,000 P, as well as the liquidus temperature and liquidus viscosity) may be measured by the rotating crucible method according to ASTM C965-96 (2017), hereby incorporated by reference in its entirety for all purposes.

In some aspects, disclosed are glasses suitable for IT applications. More specifically, in some aspects, disclosed are sodium aluminosilicate glasses free or substantially free of lithium that may be formed into cover glass for various IT applications, such as for computer screens or laptop screens, and which may be strengthened by ion exchange. In some aspects, the glasses disclosed herein incorporate at least 60 wt. % recycled glass (e.g., at least 80 wt. % recycled glass) in the batch materials, in which the balance of the batch materials comprises raw materials (e.g., sodium carbonate, silica, alumina, and so forth). As a result, the final glass that has been prepared from such batch materials contains approximately the same amount of recycled glass.

In some aspects, in target applications, such as large size display cover glass for computer monitors or laptops, flatness of glass is desired. Generally, glass with a higher Young's modulus will give higher stiffness during the forming process, such as fusion forming, which will lead to glass with less warp. Such low warp glasses are desired for large display cover glasses. Accordingly, in some aspects, the glass composition has a higher Young's modulus, such as at least 60 GPa, so as to minimize warp during the forming processes.

In some aspects, the glasses disclosed herein have one or more of the following:
ion exchangeable to result in chemically strengthened glass;
maximum compressive stress (CS) of 300-600 MPa;
depth of layer (DOL) of at least 8 μm (e.g., at least 10 μm);
achieving the indicated CS and/or DOL values within 1 hour (e.g., in a single-step IOX with at least 95 wt. % KNO₃ (e.g., 100 wt. % KNO₃) at a temperature of 430-450° C.);
free or substantially free of lithium (reduces costs and supply chain issues);
high strain point (e.g., at least 550° C., which is 100° C. above a typical 450° C. ion exchange (IOX) bath temperature) so as to reduce loss of IOX stress due to stress relaxation; high liquidus viscosity (e.g., at least 150 kP to greater than 500 kP, such as 150-12,000 kP), which facilitates the glass to be fusion formable;
low liquidus temperature (e.g., 1000° C. or less);
high Young's modulus (e.g., at least 60 GPa), so as to reduce warp from a fusion forming process;
low coefficient of thermal expansion (CTE) (e.g., lower than 70×10⁻⁷/° C.) so as to reduce warp from a fusion forming process;
any combination thereof.

In some aspects, the glasses disclosed herein have the following properties:
low liquidus temperature (e.g., 1000° C. or less); and
high liquidus viscosity (e.g., at least 150 kP, such as at least 500 kP or 150-12,000 kP); and
low coefficient of thermal expansion (CTE) (e.g., lower than 70×10⁻⁷/° C.); and
achieving a CS of 300-600 MPa and a DOL of at least 9 (e.g., at least 10 μm) within 1 hour in a single-step IOX with 100 wt. % KNO₃ at a temperature of 430-450° C.

In some aspects, disclosed are glasses comprising:
a coefficient of thermal expansion (CTE) of 70×10⁻⁷/° C. or less;
a liquidus viscosity of at least 150 kP; and
Li₂O in an amount of 0.1 wt. % or less;
wherein the glass is ion-exchangeable.

In some aspects, disclosed are glasses comprising at least one of:
a coefficient of thermal expansion (CTE) of 70×10⁻⁷/° C. or less; and
a liquidus viscosity of at least 150 kP.

In some aspects, the coefficient of thermal expansion (CTE) of a glass article may determine the possible changes of the linear size of the substrate caused by temperature changes. In some aspects, the glasses disclosed herein have a CTE of 70×10⁻⁷/° C. or less. In some aspects, the glasses disclosed herein have a CTE of at least 44×10⁻⁷/° C. In some aspects, the CTE (×10⁻⁷/° C.) is 44, 46, 48, 50, 52, 54, 56, 58, 60, 62, 64, 66, 68, or 70, in which each of the foregoing numbers can be prefaced with “at least,” “more than,” or “less than,” and in which each of the foregoing numbers can be followed by “or less” or “or more,” so as to create open-ended or closed ranges therefrom. For example, the CTE (×10⁻⁷/° C.) can be more than 44, at least 58, or 70 or less, or any range formed from any of the aforementioned numbers, such as 44-70, 44-68, 44-66, 44-64, 44-62, 44-60, 44-58, 44-56, 44-54, 44-52, 44-50, 44-48, 44-46, 46-70, 46-68, 46-66, 46-64, 46-62, 46-60, 46-58, 46-56, 46-54, 46-52, 46-50, 46-48, 48-70, 48-68, 48-66, 48-64, 48-62, 48-60, 48-58, 48-56, 48-54, 48-52, 48-50, 50-70, 50-68, 50-66, 50-64, 50-62, 50-60, 50-58, 50-56, 50-54, 50-52, 52-70, 52-68, 52-66, 52-64, 52-62, 52-60, 52-58, 52-56, 52-54, 54-70, 54-68, 54-66, 54-64, 54-62, 54-60, 54-58, 54-56, 56-70, 56-68, 56-66, 56-64, 56-62, 56-60, 56-58, 58-70, 58-68, 58-66, 58-64, 58-62, 58-60, 60-70, 60-68, 60-66, 60-64, 60-62, 62-70, 62-68, 62-66, 62-64, 64-70, 64-68, 64-66, 66-70, 66-68, or 68-70. CTE is measured herein by using a horizontal dilatometer (push-rod dilatometer) in accordance with ASTM E228-11, hereby incorporated by reference in its entirety for all purposes.

In some aspects, the glasses disclosed herein have a low content of Li₂O, are substantially free of Li₂O, or are free of Li₂O. For example, in some aspects, the glasses disclosed herein comprise Li₂O in an amount (wt. %) of less than any of the following amounts: 1, 0.9, 0.8, 0.7, 0.6, 0.5, 0.4, 0.3, 0.2, 0.1, 0.08, 0.06, 0.04, 0.02, or 0.01. In some aspects, the glasses disclosed herein comprise Li₂O in an amount (wt. %) of less than 0.5 wt. % or less than 0.1 wt. %. In some aspects, the glasses disclosed herein comprise Li₂O in an amount (wt. %) of 0.01, 0.02, 0.04, 0.06, 0.08, 0.1, 0.2, 0.3, 0.4, 0.5, 0.6, 0.7, 0.8, 0.9, or 1, in which each of the foregoing numbers can be prefaced with “at least,” “more than.” or “less than,” and in which each of the foregoing numbers can be followed by “or less” or “or more,” so as to create open-ended or closed ranges therefrom. For example, the glasses disclosed herein comprise Li₂O in an amount (wt. %) of less than 0.3, more than 0.02, or at least 0.06, or any range formed from any of the aforementioned numbers, such as 0.01-1, 0.01-0.8, 0.01-0.6, 0.01-0.4, 0.01-0.2, 0.01-0.1, 0.01-0.05, 0.05-1, 0.05-0.8, 0.05-0.6, 0.05-0.4, 0.05-0.2, 0.05-0.1, 0.1-1, 0.1-0.8, 0.1-0.6, 0.1-0.4, 0.1-0.2, 0.2-1, 0.2-0.8, 0.2-0.6, 0.2-0.4, 0.4-1, 0.4-0.8, 0.4-0.6, 0.6-1, 0.6-0.8, or 0.8-1.

In some aspects, the glasses disclosed herein are ion-exchangeable.

In some aspects, the glasses disclosed herein have a high elastic modulus (i.e., the ratio of the force exerted upon a substance or body to the resultant deformation). High elastic modulus makes a glass article more rigid and allows it to avoid large deformations under an external force that may take place. The most common of stiffness of a material is the Young's modulus E, (i.e., the relationship between stress (force per unit area) and strain (proportional deformation) in an article made of this material). The higher the Young's modulus of material, the less the deformation.

In some aspects, the glasses disclosed herein have a Young's modulus of at least 60 GPa. In some aspects, the glasses disclosed herein have a Young's modulus of 80 GPa or less. In some aspects, the glasses disclosed herein have a Young's modulus (GPa) of 60, 62, 64, 66, 68, 70, 72, 74, 76, 78, or 80, in which each of the foregoing numbers can be prefaced with “at least,” “more than,” or “less than,” and in which each of the foregoing numbers can be followed by “or less” or “or more,” so as to create open-ended or closed ranges therefrom. For example, the Young's modulus (GPa) can be 68 or less, at least 62, less than 78, or any range formed from any of the aforementioned numbers, such as 60-80, 60-78, 60-76, 60-74, 60-72, 60-70, 60-68, 60-66, 60-64, 60-62, 62-80, 62-78, 62-76, 62-74, 62-72, 62-70, 62-68, 62-66, 62-64, 64-80, 64-80, 64-78, 64-76, 64-74, 64-72, 64-70, 64-68, 64-66, 66-80, 66-78, 66-76, 66-74, 66-72, 66-70, 66-68, 68-80, 68-78, 68-76, 68-74, 68-72, 68-70, 70-80, 70-78, 70-76, 70-74, 70-72, 72-80, 72-78, 72-76, 72-74, 74-80, 74-78, 74-76, 76-80, 76-78, or 78-80.

In some aspects, after batch materials (e.g., a combination of glass cullet and raw materials) are melted, it is desirable avoid crystallization when forming a glass sheet, ribbon, or other articles from the melt. In some aspects, for glass-forming substances, one of the main numerical characteristics of the crystallization process is the liquidus temperature (TL), that specifies the minimum temperature above which a material is completely liquid, and the maximum temperature at which crystals can co-exist with the melt in thermodynamic equilibrium. This property is measured herein by the gradient method, which conforms to ASTM C829-81 Standard Practices for Measurement of Liquidus Temperature of Glass, hereby incorporated by reference in its entirety for all purposes. Accordingly, the glass forming process normally takes place at the temperature higher than TL. On the other hand, the liquidus viscosity of the glass composition can be used to determine which forming processes can be used to make glass into a sheet. Generally, the higher the liquidus viscosity, the more forming processes will be compatible with the particular glass. Since glass viscosity decreases exponentially with temperature, it is desirable to keep the liquidus temperature as low as possible to maximize the viscosity at the liquidus. For float processing the glass composition generally has a liquidus viscosity of at least 10 kP, and the fusion process generally has a liquidus viscosity of at least 20 kP, such as at least 100 kP, or at least 500 kP. For other processes, such as hot pressing, twin-rollers technique, and so forth, the viscosity value may be considerably lower and still produce an acceptable glass. For example, for hot pressing that is used on occasion in the optical industry, a liquidus viscosity of 10 to 20 poise may be satisfactory.

In some aspects, the glasses disclosed herein have a liquidus temperature of at least 700° C. In some aspects, the glasses disclosed herein have a liquidus temperature of 1000° C. or less. In some aspects, the glasses disclosed herein have a liquidus temperature (° C.) of 700, 750, 800, 850, 900, 950, or 1000, in which each of the foregoing numbers can be prefaced with “at least.” “more than.” or “less than.” and in which each of the foregoing numbers can be followed by “or less” or “or more.” so as to create open-ended or closed ranges therefrom. For example, the liquidus temperature (° C.) can be more than 800, less than 950, or 850 or less, or any range formed from any of the aforementioned numbers, such as 700-1000, 700-950, 700-900, 700-850, 700-800, 700-750, 750-1000, 750-950, 750-900, 750-850, 750-800, 800-1000, 800-950, 800-900, 800-850, 850-1000, 850-950, 850-900, 900-1000, 900-950, or 950-1000.

In some aspects, the glasses disclosed herein have a liquidus viscosity of at least 150 kilopoise (kP). In some aspects, the glasses disclosed herein have a liquidus viscosity of 18,000 kP or less. In some aspects, the glasses disclosed herein have a liquidus viscosity (kP) of 150, 200, 300, 400, 500, 1000, 1500, 2000, 2500, 3000, 3500, 4000, 4500, 5000, 6000, 7000, 8000, 9000, 10000, 12000, 14000, 16000, or 18000, in which each of the foregoing numbers can be prefaced with “at least.” “more than.” or “less than.” and in which each of the foregoing numbers can be followed by “or less” or “or more.” so as to create open-ended or closed ranges therefrom. For example, the liquidus temperature (kP) can be 500 or more, at least 8000, more than 2000, or any range formed from any of the aforementioned numbers, such as 150-18000, 150-16000, 150-10000, 150-8000, 150-6000, 150-4000, 150-2000, 150-1000, 150-500, 500-18000, 500-16000, 500-10000, 500-8000, 500-6000, 500-4000, 500-2000, 500-1000, 1000-18000, 1000-16000, 1000-10000, 1000-8000, 1000-6000, 1000-4000, 1000-2000, 2000-18000, 2000-16000, 2000-10000, 2000-8000, 2000-6000, 2000-4000, 4000-18000, 4000-16000, 4000-10000, 4000-8000, 4000-6000, 6000-18000, 6000-16000, 6000-10000, 6000-8000, 8000-18000, 8000-16000, 8000-10000, 10000-18000, 10000-16000, 10000-14000, 10000-12000, 12000-18000, 12000-16000, 12000-14000, 14000-18000, 14000-16000, or 16000-18000.

In some aspects, glass compositions may be melted at a temperature that corresponds to the glass composition having a viscosity of 200 poise (i.e., the 200 P temperature). The relationship between the viscosity and temperature of a glass-forming melt may in some aspects be a function of chemical composition of the glass that is melted. In some aspects, the glasses disclosed herein have a 200 P temperature of 1850° C. or less. In some aspects, the glasses disclosed herein have a 200 P temperature of at least 1500° C. In some aspects, the glasses disclosed herein have a 200 P temperature (° C.) of 1500, 1550, 1600, 1650, 1700, 1750, 1800, or 1850, in which each of the foregoing numbers can be prefaced with “at least.” “more than,” or “less than,” and in which each of the foregoing numbers can be followed by “or less” or “or more,” so as to create open-ended or closed ranges therefrom. For example, the 200 P temperature (° C.) can be at least 1650, more than 1650, or 1800 or more, or any range formed from any of the aforementioned numbers, such as 1500-1850, 1500-1800, 1500-1750, 1500-1700, 1500-1650, 1500-1600, 1500-1550, 1550-1850, 1550-1800, 1550-1750, 1550-1700, 1550-1650, 1550-1600, 1600-1850, 1600-1800, 1600-1750, 1600-1700, 1600-1650, 1650-1850, 1650-1800, 1650-1750, 1650-1700, 1700-1850, 1700-1800, 1700-1750, 1750-1850, 1750-1800, or 1800-1850.

In some aspects, the glasses disclosed herein have a 35,000 P temperature of at least 950° C. In some aspects, the glasses disclosed herein have a 35,000 P temperature of 1250° C. or less. In some aspects, the glasses disclosed herein have a 35,000 P temperature (° C.) of 950, 975, 1000, 1025, 1050, 1075, 1100, 1125, 1150, 1175, 1200, 1225, or 1250, in which each of the foregoing numbers can be prefaced with “at least,” “more than,” or “less than,” and in which each of the foregoing numbers can be followed by “or less” or “or more.” so as to create open-ended or closed ranges therefrom. For example, the 35,000 P temperature (° C.) can be 1200 or less, at least 1000, or more than 1125, or any range formed from any of the aforementioned numbers, such as 950-1250, 950-1200, 950-1150, 950-1100, 950-1050, 950-1000, 975-1175, 1000-1250, 1000-1200, 1000-1150, 1000-1100, 1000-1050, 1050-1250, 1050-1200, 1050-1150, 1050-1100, 1100-1250, 1100-1200, 1100-1150, 1150-1250, 1150-1200, or 1200-1250.

In some aspects, the glasses disclosed herein have a strain point of at least 475° C. In some aspects, the glasses disclosed herein have a liquidus temperature of 625° C. or less. In some aspects, the glasses disclosed herein have a strain point (° C.) of 475, 500, 525, 550, 575, 600, or 625, in which each of the foregoing numbers can be prefaced with “at least.” “more than,” or “less than,” and in which each of the foregoing numbers can be followed by “or less” or “or more,” so as to create open-ended or closed ranges therefrom. For example, the strain point (° C.) can be 600 or more, at least 525, 550 or less, or any range formed from any of the aforementioned numbers, such as 475-625, 475-600, 475-575, 475-550, 475-525, 475-500, 500-625, 500-600, 500-575, 500-550, 500-525, 525-625, 525-600, 525-575, 525-550, 550-625, 550-600, 550-575, 575-625, 575-600, or 600-625.

In some aspects, when the glasses disclosed herein have a thickness of 1 mm and are subjected to a single step ion exchange in a 100 wt. % KNO₃ molten salt bath at 430-450° C., the glass achieves a maximum compressive stress (CS) of at least 300 MPa (e.g., 300-600 MPa) and a depth of layer (DOL) of at least 5 μm within 4 hours (e.g., within 1 hour). In some aspects, the CS (MPa) achieved under such conditions is 300, 325, 350, 375, 400, 425, 450, 475, 500, 525, 550, 575, or 600, in which each of the foregoing numbers can be prefaced with “at least,” “more than,” or “less than,” and in which each of the foregoing numbers can be followed by “or less” or “or more,” so as to create open-ended or closed ranges therefrom. For example, the CS (MPa) achieved under such conditions can be at least 300, 525 or more, 575 or less, or any range formed from any of the aforementioned numbers, such as 300-600, 300-550, 300-500, 300-450, 300-400, 300-350, 350-600, 350-575, 350-550, 350-500, 350-450, 350-425, 350-400, 400-600, 400-550, 400-525, 400-500, 400-450, 450-600, 450-550, 450-500, 500-600, 500-550, or 550-600. In some aspects, the DOL (μm) achieved under such conditions is 8, 10, 12, 14, 16, 18, 20, 22, or 24, in which each of the foregoing numbers can be prefaced with “at least,” “more than,” or “less than,” and in which each of the foregoing numbers can be followed by “or less” or “or more,” so as to create open-ended or closed ranges therefrom. For example, the DOL (μm) can be at least 8, 10 or more, less than 22, or any range formed from any of the aforementioned numbers, such as 8-24, 8-22, 8-20, 8-18, 8-16, 8-14, 8-12, 8-10, 10-24, 10-22, 10-20, 10-18, 10-16, 10-14, 10-12, 12-24, 12-22, 12-20, 12-18, 12-16, 12-14, 14-24, 14-22, 14-20, 14-18, 14-16, 16-24, 16-22, 16-20, 16-18, 18-24, 18-22, 18-20, 20-24, 20-22, or 22-24. In some aspects, such CS and DOL values can be achieved in a time period (hours) of 0.5, 1, 1.5, 2, 2.5, 3, 3.5, or 4, in which each of the foregoing numbers can be prefaced with “at least,” “more than,” or “less than,” and in which each of the foregoing numbers can be followed by “or less” or “or more,” so as to create open-ended or closed ranges therefrom (note that “within X hours” has the same meaning as “X hours or less”). For example, the time period (hours) can be 1 or less, less than 2, 0.5 or more, or any range formed from any of the aforementioned numbers, such as 0.5-4, 0.5-3.5, 0.5-3, 0.5-2.5, 0.5-2, 0.5-1.5, 0.5-1, 1-4, 1-3.5, 1-3, 1-2.5, 1-2, 1-1.5, 1.5-4, 1.5-3.5, 1.5-3, 1.5-2.5, 1.5-2, 2-4, 2-3.5, 2-3, 2-2.5, 2.5-4, 2.5-3.5, 2.5-3, 3-4, 3-3.5, or 3.5-4.

In some aspects, the glasses herein comprise one or more of SiO₂, Al₂O₃, B₂O₃, Na₂O, K₂O, CaO, Li₂O, MgO, and SnO₂. In some aspects, the glasses herein comprise SiO₂, Al₂O₃, B₂O₃, Na₂O, K₂O, and CaO. In some aspects, the glasses herein comprise SiO₂, Al₂O₃, B₂O₃, Na₂O, K₂O, and CaO, in which the weight ratio of Na₂O/Al₂O₃ is less than or equal to 0.9. In some aspects, the glasses herein comprise SiO₂, Al₂O₃, B₂O₃, Na₂O, K₂O, and CaO, and the glasses are substantially free of Li₂O or contain Li₂O in an amount less than 0.1 wt. %. In some aspects, the glasses herein comprise SiO₂, Al₂O₃, B2O₃, Na₂O, K₂O, and CaO, less than 0.1 wt. % Li₂O (or are substantially free of Li₂O), and optionally one or more of MgO and SnO₂. In some aspects, the glasses herein comprise an aluminoborosilicate glass, such as alkali aluminoborosilicate glass (e.g., wherein the alkali is Li, Na, and/or K).

In some aspects, the glasses herein comprise:
SiO₂ in an amount of 64-73 wt. % (e.g., 66-72 wt. %);
Al₂O₃ in an amount of 7-15 wt. % (e.g., 8-15 or 8-14 wt. %);
B₂O₃ in an amount of 9-11 wt. %;
Na₂O in an amount of 6-9.5 wt. % (e.g., 6.5-9 wt. %);
K₂O in an amount of 0.5-3 wt. % (e.g., 1-2.5 wt. %);
CaO in an amount of at least 0.05 wt. % (e.g., 0.1-5 or 0.1-2 wt. %); and
Li₂O in an amount of 0.1 wt. % or less (or the glass is substantially free of Li₂O);
wherein a weight ratio of Na₂O/Al₂O₃ is less than or equal to 0.9.

In some aspects, the glasses herein further comprise:
CaO in an amount of 0.1-2 wt. %
MgO in an amount of 0-1 wt. %; and
SnO₂ in an amount of 0-1 wt. %.

In some aspects, the glasses herein may include silica (SiO₂). In some aspects, the main glass-forming component is silica (SiO₂), which is the largest constituent of the materials to be melted into glass and, as such, is the primary constituent of the resulting glass network. Without being bound to theory, SiO₂ enhances the chemical durability of the glass and, in particular, the resistance of the glass to decomposition in acid and the resistance of the glass to decomposition in water. If the content of SiO₂ is too low, the chemical durability and chemical resistance of the glass may be reduced and the glass may be susceptible to corrosion. Accordingly, in some aspects, a high SiO₂ concentration is generally desired. However, if the content of SiO₂ is too high, the formability of the glass may be diminished as higher concentrations of SiO₂ may increase the difficulty of melting the glass which, in turn, adversely impacts the formability of the glass. Accordingly, it is desired to include SiO₂ in a balanced manner so as to achieve desired properties.

In some aspects, the glasses herein comprise SiO₂. In some aspects, the glasses herein comprise SiO₂ in an amount of at least 62 wt. %. In some aspects, the glasses herein comprise SiO₂ in an amount of 75 wt. % or less. In some aspects, the glasses herein comprise SiO₂ in an amount (wt. %) of 62, 63, 64, 65, 66, 67, 68, 69, 70, 71, 72, 73, 74, or 75, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise SiO₂ in an amount (wt. %) of at least 64, 73 or less, 68 or more, or any range formed from any of the aforementioned numbers, such as 62-75, 62-74, 62-73, 62-72, 62-71, 62-70, 62-69, 62-68, 62-66, 62-64, 63-75, 63-72, 63-70, 63-68, 63-66, 63-64, 64-73, 64-75, 64-74, 64-72, 64-70, 64-68, 64-66, 66-75, 66-74, 66-72, 66-70, 66-68, 68-75, 68-74, 68-72, 68-70, 70-75, 70-74, 70-72, 72-75, 72-74, 73-75, or 74-75. In some aspects, the glasses herein are free of, or substantially free of, SiO₂.

In some aspects, the glasses herein comprise alumina (Al₂O₃). In some aspects, Al₂O₃, in conjunction with alkali metal oxides present in the glass compositions such as Na₂O, or the like, improves the susceptibility of the glass to ion exchange strengthening. More specifically, in some aspects, increasing the amount of Al₂O₃ in the glasses increases the speed of ion exchange in the glasses and increases the compressive stress produced in the compressive layer of the glasses as a result of ion exchange.

In some aspects, the glasses herein comprise Al₂O₃. In some aspects, the glasses herein comprise Al₂O₃ in an amount of at least 5 wt. %. In some aspects, the glasses herein comprise Al₂O₃ in an amount of 18 wt. % or less. In some aspects, the glasses herein comprise Al₂O₃ in an amount (wt. %) of 5, 6, 7, 8, 9, 10, 11, 12, 13, 14, 15, 16, 17, or 18, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise Al₂O₃ in an amount (wt. %) of at least 8, 15 or less, less than 13, or any range formed from any of the aforementioned numbers, such as 5-18, 5-16, 5-15, 5-14, 5-12, 5-10, 5-8, 5-6, 6-18, 6-16, 6-15, 6-14, 6-12, 6-11, 6-10, 6-8, 6-7, 7-18, 7-16, 7-15, 7-14, 7-12, 7-10, 7-8, 8-18, 8-16, 8-15, 8-14, 8-13, 8-11, 8-9, 9-18, 9-16, 9-15, 9-14, 9-12, 9-10, 10-18, 10-16, 10-14, 10-12, 10-11, 11-18, 11-17, 11-16, 11-15, 11-13, 11-12, 12-18, 12-16, 12-14, 12-13, 13-18, 13-16, 13-14, 14-18, 14-17, 14-15, 15-18, 15-17, 15-16, 16-18, 16-17, or 17-18. In some aspects, the glasses herein are free of, or substantially free of, Al₂O₃.

In some aspects, the glasses herein comprise boron oxide (B₂O₃). In some aspects, B₂O₃ is a flux which may be added to glass compositions to reduce the viscosity of the glass at a given temperature (e.g., the temperature corresponding to the viscosity of 200 poise or a 200 P temperature, at which glass is melted), thereby improving the quality and formability of the glass. In some aspects, the presence of B₂O₃ may also improve damage resistance of the glass made from the glass composition.

In some aspects, the glasses herein comprise B₂O₃. In some aspects, the glasses herein comprise B₂O₃ in an amount of at least 5 wt. %. In some aspects, the glasses herein comprise B₂O₃ in an amount of 15 wt. % or less. In some aspects, the glasses herein comprise B₂O₃ in an amount (wt. %) of 5, 6, 7, 8, 9, 10, 11, 12, 13, 14, or 15, in which each of the foregoing numbers can be prefaced with “at least.” “more than,” or “less than,” and in which each of the foregoing numbers can be followed by “or less” or “or more,” so as to create open-ended or closed ranges therefrom. For example, the glasses herein can comprise B₂O₃ in an amount (wt. %) of at least 9, less than 13, 11 or less, or any range formed from any of the aforementioned numbers, such as 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15. In some aspects, the glasses herein are free of, or substantially free of, B₂O₃.

In some aspects, the glasses herein comprise Li₂O. In some aspects, the glasses herein have a low amount of Li₂O. In some aspects, a low amount of Li₂O is desired to reduce costs due to the high cost of lithium. In some aspects, the glasses herein are free of Li₂O. In some aspects, the glasses herein are substantially free of Li₂O. In some aspects, the glasses herein comprise Li₂O in an amount (wt. %) of 0, >0, or at least 0.01. In some aspects, the glasses herein comprise Li₂O in an amount (wt. %) of 1 or less. In some aspects, the glasses herein comprise Li₂O in an amount (wt. %) of 0, >0, 0.01, 0.05, 0.1, 0.2, 0.4, 0.6, 0.6, 0.8, or 1, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise Li₂O in an amount (wt. %) of 0.1 or less, 0.01 or more, less than 0.4, or any range formed from any of the aforementioned numbers, such as 0-1, 0-0.8, 0-0.6, 0-0.4, 0-0.2, 0-0.1, 0-0.05, 0-0.01, >0-1, >0-0.8, >0-0.6, >0-0.4, >0-0.2, >0-0.1, >0-0.05, >0-0.01, 0.01-1, 0.01-0.8, 0.01-0.6, 0.01-0.4, 0.01-0.2, 0.01-0.1, 0.01-0.05, 0.05-1, 0.05-0.8, 0.05-0.6, 0.05-0.4, 0.05-0.2, 0.05-0.1, 0.1-1, 0.1-0.8, 0.1-0.6, 0.1-0.4, 0.1-0.2, 0.2-1, 0.2-0.8, 0.2-0.6, 0.2-0.4, 0.4-1, 0.4-0.8, 0.4-0.6, 0.6-1, 0.6-0.8, or 0.8-1.

In some aspects, alkalis other than Li₂O, such as Na₂O, K₂O, Rb₂O, Cs₂O, or any combination thereof, may be present in the glasses disclosed herein. In some aspects, these alkalis may reduce the liquidus temperature and increase the liquidus viscosity, thus avoiding crystallization in the melt at high temperatures. However, in some aspects these components can generate undesirable effects, such as increasing the density and CTE. Therefore, in some aspects, the glasses herein are free of, are substantially free of, or contain relatively low amounts of one or more of these alkalis. Na₂O and K₂O are discussed in more detail elsewhere herein, but with respect to Rb₂O and Cs₂O, the glasses herein can be free of or substantially free of such components, or the glasses herein may comprise Rb₂O or Cs₂O individually in an amount (wt. %) of 0, >0, 0.5, 1, 1.5, or 2, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise Rb₂O or Cs₂O individually in an amount (wt. %) of 2 or less, less than 1.5, at least 0.5, or any range formed from any of the aforementioned numbers, such as 0-2, 0-1.5, 0-1, 0-0.5, >0-2, >0-1.5, >0-1, >0-0.5, 0.5-2, 0.5-1.5, 0.5-1, 1-2, 1-1.5, or 1.5-2. For clarity, any of the foregoing amounts apply to each of Rb₂O and Cs₂O individually, such that the glasses herein may comprise Rb₂O in an amount of 1 wt. % and Cs₂O in an amount of 2 wt. %, for example.

In some aspects, the glasses herein comprise sodium oxide (Na₂O). In some aspects, the amount of Na₂O in the glasses relates to the ion exchangeability of the glass. Specifically, in some aspects the presence of Na₂O in the glass may increase the ion exchange rate during ion exchange strengthening of the glass by increasing the diffusivity of Na⁺ ions through the glass matrix. In some aspects, Na₂O is included in an amount that facilitates achieving the desired DOL and CS, such as in an amount of at least 5 wt. % or at least 6 wt. %. Also, in some aspects, Na₂O may suppress the crystallization of alumina containing species, such as spodumene, mullite, and/or corundum and, therefore, Na₂O may decrease the liquidus temperature and increase the liquidus viscosity. However, in some aspects, increasing the Na₂O amount in the glass may increase CTE. Also, in some aspects, Na₂O may increase CTE and potentially negatively affect the mechanical properties of glass since Na₂O can decrease the elastic modulus and the fracture toughness, and/or decrease the annealing and strain points of glass. Accordingly, it may be desirable in some aspects to limit or otherwise balance the amount of Na₂O present in the glasses disclosed herein.

In some aspects, the glasses herein comprise Na₂O in an amount of at least 5 wt. %. In some aspects, the glasses herein comprise Na₂O in an amount of 11 wt. % or less. In some aspects, the glasses herein comprise Na₂O in an amount (wt. %) of 5, 5.5, 6, 6.5, 7, 7.5, 8, 8.5, 9, 9.5, 10, 10.5, or 11, in which each of the foregoing numbers can be prefaced with “at least.” “more than,” or “less than,” and in which each of the foregoing numbers can be followed by “or less” or “or more,” so as to create open-ended or closed ranges therefrom. For example, the glasses herein can comprise Na₂O in an amount (wt. %) of at least 6, 7.5 or more, 9.5 or less, or any range formed from any of the aforementioned numbers, such as 5-11, 5-10, 5-9.5, 5-9, 5-8, 5-7, 5-6, 6.5-9.5, 6-11, 6-10.5, 6-10, 6-9.5, 6-9, 6-8, 6-7, 6.5-11, 6.5-10.5, 6.5-10, 6.5-9.5, 6.5-9, 6.5-8.5, 6.5-8, 6.5-7.5, 6.5-7, 7-11, 7-10.5, 7-10, 7-9.5, 7-9, 7-8, 8-11, 8-10.5, 8-10, 8-9.5, 8-9, 8-8.5, 9-11, 9-10.5, 9-10, 9-9.5, 9.5-11, 9.5-10.5, 9.5-10, or 10-11. In some aspects, the glasses herein are free of, or substantially free of, Na₂O.

In some aspects, the glasses herein may comprise a weight ratio of Na₂O/Al₂O₃. In some aspects, the glasses herein comprise a weight ratio of Na₂O/Al₂O₃ of at least 0.3. In some aspects, the glasses herein comprise a weight ratio of Na₂O/Al₂O₃ of less than 1. In some aspects, the glasses herein comprise a weight ratio of Na₂O/Al₂O₃ of 0.3, 0.35, 0.4, 0.45, 0.5, 0.55, 0.6, 0.65, 0.7, 0.75, 0.8, 0.85, 0.9, 0.95, or 1, in which each of the foregoing numbers can be prefaced with “at least.” “more than,” or “less than,” and in which each of the foregoing numbers can be followed by “or less” or “or more.” so as to create open-ended or closed ranges therefrom. For example, the glasses herein can comprise a weight ratio of Na₂O/Al₂O₃ of less than 1, 0.9 or less, less than 0.95, 0.5 or more, or any range formed from any of the aforementioned numbers, such as 0.3-1, 0.3-0.95, 0.3-0.9, 0.3-0.85, 0.3-0.8, 0.3-0.75, 0.3-0.7, 0.3-0.65, 0.3-0.6, 0.3-0.55, 0.3-0.5, 0.3-0.45, 0.3-0.4, 0.3-0.35, 0.35-1, 0.35-0.95, 0.35-0.9, 0.35-0.85, 0.35-0.8, 0.35-0.75, 0.35-0.7, 0.35-0.65, 0.35-0.6, 0.35-0.55, 0.35-0.5, 0.35-0.45, 0.35-0.4, 0.4-1, 0.4-0.95, 0.4-0.9, 0.4-0.85, 0.4-0.8, 0.4-0.75, 0.4-0.7, 0.4-0.65, 0.4-0.6, 0.4-0.55, 0.4-0.5, 0.4-0.45, 0.45-1, 0.45-0.95, 0.45-0.9, 0.45-0.85, 0.45-0.8, 0.45-0.75, 0.45-0.7, 0.45-0.65, 0.45-0.6, 0.45-0.55, 0.45-0.5, 0.5-1, 0.5-0.95, 0.5-0.9, 0.5-0.85, 0.5-0.8, 0.5-0.75, 0.5-0.7, 0.5-0.65, 0.5-0.6, 0.5-0.55, 0.6-1, 0.6-0.95, 0.6-0.9, 0.6-0.85, 0.6-0.8, 0.6-0.75, 0.6-0.7, 0.6-0.65, 0.65-1, 0.65-0.95, 0.65-0.9, 0.65-0.85, 0.65-0.8, 0.65-0.75, 0.65-0.7, 0.7-1, 0.7-0.95, 0.7-0.9, 0.7-0.85, 0.7-0.8, 0.7-0.75, 0.75-1, 0.75-0.95, 0.75-0.9, 0.75-0.85, 0.75-0.8, 0.8-1, 0.8-0.95, 0.8-0.9, 0.8-0.85, 0.85-1, 0.85-0.95, 0.85-0.9, 0.9-1, 0.9-0.95, or 0.95-1.

In some aspects, the glasses herein may include potassium oxide (K₂O). In some aspects, the presence and/or amount of K₂O in the glass compositions also relates to the ion exchangeability of the glass. Specifically, in some aspects, as the amount of K₂O present in the glass increases, the compressive stress in the glass obtainable through ion exchange decreases as a result of the exchange of potassium and sodium ions. Also, the potassium oxide, like the sodium oxide, in some aspects may decrease the liquidus temperature and increase the liquidus viscosity, but at the same time may decrease the elastic modulus and fracture toughness, and may increase CTE. Accordingly, in some aspects, it is desirable to limit or otherwise balance the amount of K₂O present in the glasses disclosed herein.

In some aspects, the glasses herein comprise K₂O in an amount of 0 wt. %, >0 wt. %, or at least 0.5 wt. %. In some aspects, the glasses herein comprise K₂O in an amount of 3 wt. % or less. In some aspects, the glasses herein comprise K₂O in an amount (wt. %) of 0, >0, 0.1, 0.5, 1, 1.5, 2, 2.5, or 3, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise K₂O in an amount (wt. %) of more than 0, at least 0.5, less than 3, 2.5 or less, or any range formed from any of the aforementioned numbers, such as 0-3, 0-2.5, 0-2, 0-1.5, 0-1, 0-0.5, 0-0.1, >0-3, >0-2.5, >0-2, >0-1.5, >0-1, >0-0.5, >0-0.1, 0.1-3, 0.1-2.5, 0.1-2, 0.1-1.5, 0.1-1, 0.1-0.5, 0.5-3, 0.5-2.5, 0.5-2, 0.5-1.5, 0.5-1, 1-3, 1-2.5, 1-2, 1-1.5, 1.5-3, 1.5-2.5, 1.5-2, 2-3, 2-2.5, or 2.5-3.

In some aspects, the glasses herein comprise calcium oxide (CaO). In some aspects, CaO is a flux which may be added to glass compositions to reduce the viscosity of the glass at a given temperature (e.g., the temperature corresponding to the viscosity of 200 poise or a 200 P temperature, at which glass is melted), thereby improving the quality and formability of the glass. In some aspects, comparing with Na₂O. CaO may reduce the CTE of the glass. However, too much CaO in a glass composition may decrease the rate of ion exchange in the resultant glass and cause phase separation in high B₂O₃ containing glasses. Accordingly, in some aspects, the content of calcium oxide is preferably limited or at least is balanced so as to achieve desired properties/effects and avoid undesired properties/effects.

In some aspects, the glasses herein comprise CaO in an amount of at least 0.05 wt. %. In some aspects, the glasses herein comprise CaO in an amount of 5 wt. % or less. In some aspects, the glasses herein comprise CaO in an amount (wt. %) of 0.05, 0.1, 0.2, 0.3, 0.4, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise CaO in an amount (wt. %) of more than 0.05, at least 0.1, 2 or less, or any range formed from any of the aforementioned numbers, such as 0.05-5, 0.05-4.5, 0.05-4, 0.05-3.5, 0.05-3, 0.05-2.5, 0.05-2, 0.05-1.5, 0.05-1, 0.05-0.5, 0.05-0.4, 0.05-0.3, 0.05-0.2, 0.05-0.1, 0.1-5, 0.1-4.5, 0.1-4, 0.1-3.5, 0.1-3, 0.1-2.5, 0.1-2, 0.1-1, 0.1-0.5, 0.1-0.4, 0.1-0.3, 0.1-0.2, 0.2-5, 0.2-4.5, 0.2-4, 0.2-3.5, 0.2-3, 0.2-2.5, 0.2-2, 0.2-1.5, 0.2-1, 0.2-0.5, 0.2-0.4, 0.2-0.3, 0.4-5, 0.4-4.5, 0.4-4, 0.4-3.5, 0.4-3, 0.4-2.5, 0.4-2, 0.4-1.5, 0.4-1, 0.4-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In some aspects, the glasses herein are free of, or substantially free of, CaO.

In some aspects, the glasses herein comprise magnesia (MgO). In some aspects, it was empirically found that magnesia increases the elastic moduli to a greater extent than other divalent metal oxides, except for BeO, and does not provide an adverse increase to the density. However, in some aspects when MgO is added in a high concentration, it can increase the liquidus temperature and cause precipitation of refractory minerals, such as spinel (MgAl₂O₄), forsterite (Mg₂SiO₄) and/or others, from the glass forming melts at high temperatures. Also, in some aspects, at high concentrations, MgO can slow down the ion exchange. Accordingly, it may be desirable in some aspects to limit the content of magnesia and/or otherwise balance its effects with other components.

In some aspects, the glasses herein comprise MgO in an amount of 0 wt. % or >0 wt. %. In some aspects, the glasses herein comprise MgO in an amount of 5 wt. % or less. In some aspects, the glasses herein comprise MgO in an amount (wt. %) of 0, >0, 0.1, 0.2, 0.3, 0.4, 0.5, 0.6, 0.7, 0.8, 0.9, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise MgO in an amount (wt. %) of at least 0.1, 0.5 or more, 1 or less, or any range formed from any of the aforementioned numbers, such as 0-5, 0-4.5, 0-4, 0-3.5, 0-3, 0-2.5, 0-2, 0-1.5, 0-1, 0-0.8, 0-0.5, 0-0.3, 0-0.1, >0-5, >0-4.5, >0-4, >0-3.5, >0-3, >0-2.5, >0-2, >0-1.5, >0-1, >0-0.7, >0-0.5, >0-0.2, >0-0.1, 0.1-5, 0.1-4.5, 0.1-4, 0.1-3.5, 0.1-3, 0.1-2.5, 0.1-2, 0.1-1.5, 0.1-1, 0.1-0.6, 0.1-0.5, 0.1-0.2, 0.2-5, 0.2-4.5, 0.2-4, 0.2-3, 0.2-2, 0.2-1, 0.2-0.8, 0.2-0.6, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein comprise tin oxide (SnO₂). In some aspects, tin oxide can be added to the glass compositions as a fining agent (e.g., in low concentrations). However, in some aspects it was empirically found that, in some cases, precipitation of cassiterite occurs, sometimes when the content of Al₂O₃ is greater than or equal to the total content of modifiers. In some aspects, inclusion of small amounts of SnO₂, sometimes less than 0.25 mol. %, or even less than 0.1 mol. %, may cause precipitation of cassiterite (SnO₂) from the melt at high temperatures. Accordingly, in some aspects, the content of tin oxide is limited, or glass compositions may be substantially free of SnO₂, or at least the amount of tin oxide is balanced with other components so as to achieve the desired properties/effects.

In some aspects, the glasses herein comprise SnO₂ in an amount of 0 wt. % or >0 wt. %. In some aspects, the glasses herein comprise SnO₂ in an amount of 5 wt. % or less. In some aspects, the glasses herein comprise SnO₂ in an amount (wt. %) of 0, >0, 0.1, 0.2, 0.3, 0.4, 0.5, 0.6, 0.7, 0.8, 0.9, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise SnO₂ in an amount (wt. %) of at least 0.1, 0.5 or more, 1 or less, or any range formed from any of the aforementioned numbers, such as 0-5, 0-4.5, 0-4, 0-3.5, 0-3, 0-2.5, 0-2, 0-1.5, 0-1, 0-0.8, 0-0.5, 0-0.3, 0-0.1, >0-5, >0-4.5, >0-4, >0-3.5, >0-3, >0-2.5, >0-2, >0-1.5, >0-1, >0-0.7, >0-0.5, >0-0.2, >0-0.1, 0.1-5, 0.1-4.5, 0.1-4, 0.1-3.5, 0.1-3, 0.1-2.5, 0.1-2, 0.1-1.5, 0.1-1, 0.1-0.6, 0.1-0.5, 0.1-0.2, 0.2-5, 0.2-4.5, 0.2-4, 0.2-3, 0.2-2, 0.2-1, 0.2-0.8, 0.2-0.6, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein comprise barium oxide (BaO). Barium oxide (and, in some aspects, strontium oxide) can be added to the glass compositions of the present disclosure to reduce the high-temperature viscosity and improve the meltability. However, in some aspects, addition of BaO, even in small concentrations, such as 1 mol. % or even less, may significantly decrease the elastic moduli and fracture toughness of glass. In some aspects, BaO increases CTE and the density of glass. Also, in some aspects, it was empirically found that sometimes addition of BaO may increase the liquidus temperature. Accordingly, in some aspects, it may be desirable to limit the content of barium oxide, or glass compositions may be substantially free of BaO.

In some aspects, the glasses herein comprise BaO in an amount of 0 wt. % or >0 wt. %. In some aspects, the glasses herein comprise BaO in an amount of 5 wt. % or less. In some aspects, the glasses herein comprise BaO in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise BaO in an amount (wt. %) of 0.1 or more, less than 1, 2 or less, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein comprise zinc oxide (ZnO). In some aspects, the glasses herein may contain a small amount of ZnO. In some aspects, ZnO may partially compensate any excess of Al₂O₃, which leads to at least some suppression of crystallization of mullite and, therefore, reduces the liquidus temperature and increases the liquidus viscosity. In some aspects, at an excess of Al₂O₃, ZnO, solely or together with the magnesium oxide, may form spinel that may crystallize at high temperatures and, therefore, in this case ZnO may increase the liquidus temperature and reduce the liquidus viscosity. Accordingly, in some aspects, it may be desired to limit the content of ZnO. In some aspects, a small amount of ZnO (less than 2 mol %) could be added to glasses herein to prevent photo darkening from UV light exposure, which sometimes is used in glass cleaning processes.

In some aspects, the glasses herein comprise ZnO in an amount of 0 wt. % or >0 wt. %. In some aspects, the glasses herein comprise ZnO in an amount of 5 wt. % or less. In some aspects, the glasses herein comprise ZnO in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise ZnO in an amount (wt. %) of 0.1 or more, less than 1, 2 or less, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein may comprise rare earth metal oxides (REOs). In some aspects, the glasses herein may comprise a limited amount of rare earth metal oxides. In some aspects, rare earth metal oxides may be added to the glass composition to provide a number of physical and chemical attributes to the resulting glass. as used herein, rare earth metal oxides refer to the oxides of metals listed in the Lanthanide Series of the IUPAC Periodic Table plus yttrium and scandium. In some aspects, the presence of rare earth metal oxides in the glass composition may increase the modulus, stiffness, or modulus and stiffness of the resultant glass. In some aspects, rare earth metal oxides may increase the liquidus viscosity of the glass composition. In some aspects, certain rare earth metal oxides may add color to a glass. In some aspects, if no color is required or desired, then the glass composition may include lanthanum oxide (La₂O₃), yttrium oxide (Y₂O₃), gadolinium oxide (Gd₂O₃), ytterbium oxide (Yb₂O₃), lutetium oxide (Lu₂O₃), or any combination thereof. In some aspects, if a colored glass is desired, a glass herein may include rare earth metal oxides such as Ce₂O₃, Pr₂O₃, Nd₂O₃, Sm₂O₃, Eu₂O₃, Tb₂O₃, Dy₂O₃, HO₂O₃, Er₂O₃, Tm₂O₃, or any combination thereof. In some aspects, certain rare earth metal oxides such as Ce₂O₃ and Gd₂O₃ absorb UV radiation, and therefore such rare earth metal oxides may be employed in cover glasses so as to protect OLED display devices from deleterious UV radiation.

In some aspects, rare earth metal oxides can be added in small concentrations to the glass compositions to provide higher elastic moduli, higher fracture toughness, and/or higher low-temperature viscosity, while in some aspects at the same time reducing the high-temperature viscosity of the glass forming melts, which can save energy when melting. However, in some aspects, at high concentrations of REₘOₙ, the liquidus viscosity of glass can be decreased. Also, in some aspects, rare earth metal oxides are comparably expensive, and they may slow down the process of ion exchange. Accordingly, in some aspects it may be desirable to limit the content of rare earth metal oxides, or the glasses herein may be substantially free of REₘOₙ, or the amount of REOs may be balanced with other components so as to provide a glass with desired properties.

In some aspects, the glasses herein comprise REOs individually in an amount of 0 wt. % or >0 wt. %. In some aspects, the glasses herein comprise REOs individually in an amount of 5 wt. % or less. In some aspects, the glasses herein comprise any REO individually in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise any REO individually in an amount (wt. %) of 0.1 or more, less than 1, 2 or less, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. For clarity, any REO individually can be included in a glass at the aforementioned amount, and any combination of REOs may be employed, in which each REO is individually present at any of the aforementioned amounts. So, for example, Lu₂O₃ can be employed in a glass in a amount of 1-3 wt. % and Tm₂O₃ can be employed in the same glass in an amount of 3-5 wt. %.

In some aspects, the glasses herein comprise titania (TiO₂). In some aspects, titania can be added to the glasses to increase the elastic moduli and fracture toughness of glass without significant increase of the density. However, in some aspects titania may slow down the process of the ion exchange. Also, in some aspects titania may provide undesirable coloring to the glass. Accordingly, in some aspects it may be desirable to limit the content of titania or otherwise balance its effects in the glass. In some aspects, a small amount of titania (less than 0.1 mol %) could added into glass to prevent photo darkening from UV light exposure, which sometime is used in glass cleaning process.

In some aspects, the glasses herein comprise TiO₂ in an amount of 0 wt. % or >0 wt. %. In some aspects, the glasses herein comprise TiO₂ in an amount of 5 wt. % or less. In some aspects, the glasses herein comprise TiO₂ in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise TiO₂ in an amount (wt. %) of 0.1 or more, less than 1, 2 or less, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein comprise zirconia (ZrO₂). In some aspects, zirconia can be added in a small concentrations to the glasses to increase the elastic moduli, fracture toughness, and/or low-temperature viscosity. However, in some aspects it was empirically found that in aluminosilicate glasses with high content of alumina, addition of even very small amounts of ZrO₂, such as 1 mol. % or even less, may increase the liquidus temperature and, therefore, may in some aspects adversely cause crystallization of the refractory minerals, such as zirconia (ZrO₂), zircon (ZrSiO₄) and others, from the glass forming melt at high temperatures. Accordingly, in some aspects, it may be desirable to limit the content of zirconia or otherwise balance its effects in the glass, or the glass compositions may be substantially free of ZrO₂.

In some aspects, the glasses herein comprise ZrO₂ in an amount of 0 wt. % or >0 wt. %. In some aspects, the glasses herein comprise ZrO₂ in an amount of 5 wt. % or less. In some aspects, the glasses herein comprise ZrO₂ in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise ZrO₂ in an amount (wt. %) of 0.1 or more, less than 1, 2 or less, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glasses herein comprise fluorides and/or chlorides (e.g., added to the composition to be melted as NaF, NaCl, KF, KCl). In some aspects, fluorides and/or chlorides are present in glass cullet, and therefore in the glasses herein that result from combining and melting glass cullet and raw materials. In some aspects, the fluorides and/or chlorides are present in the glass cullet and therefore the glasses herein in small concentrations as fining agents.

In some aspects, the glasses herein comprise Cl or F individually in an amount of 0 wt. % or >0 wt. %. In some aspects, the glasses herein comprise Cl or F individually in an amount of 1 wt. % or less. In some aspects, the glasses herein comprise Cl or F individually in an amount (wt. %) of 0, >0, 0.01, 0.05, 0.1, 0.15, 0.2, 0.3, 0.4, 0.5, 0.6, 0.7, 0.8, 0.9, or 1, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses herein can comprise Cl or F individually in an amount (wt. %) of 0.05 or more, less than 0.3, 0.6 or less, or any range formed from any of the aforementioned numbers, such as 0-1, 0-0.9, 0-0.8, 0-0.7, 0-0.6, 0-0.5, 0-0.4, 0-0.3, 0-0.2, 0-0.15, 0-0.1, 0-0.05, 0-0.01, >0-1, >0-0.9, >0-0.8, >0-0.7, >0-0.6, >0-0.5, >0-0.4, >0-0.3, >0-0.2, >0-0.15, >0-0.1, >0-0.05, >0-0.01, 0.01-1, 0.01-0.9, 0.01-0.8, 0.01-0.7, 0.01-0.6, 0.01-0.5, 0.01-0.4, 0.01-0.3, 0.01-0.2, 0.01-0.15, 0.01-0.1, 0.01-0.05, 0.05-1, 0.05-0.9, 0.05-0.8, 0.05-0.7, 0.05-0.6, 0.05-0.5, 0.05-0.4, 0.05-0.3, 0.05-0.2, 0.05-0.15, 0.05-0.1, 0.1-1, 0.1-0.9, 0.1-0.8, 0.1-0.7, 0.1-0.6, 0.1-0.5, 0.1-0.4, 0.1-0.3, 0.1-0.2, 0.1-0.15, 0.15-1, 0.15-0.9, 0.15-0.8, 0.15-0.7, 0.15-0.6, 0.15-0.5, 0.15-0.4, 0.15-0.3, 0.15-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.7-1, 0.7-0.9, 0.7-0.8, 0.8-1, 0.8-0.9, or 0.9-1.

In some aspects, the glasses disclosed herein can be subjected to ion exchange (IOX) so as to result in a chemically-strengthened glass-based article. In some aspects, the ion-exchanged glass-based article comprises a composition at its center that is the same as disclosed elsewhere herein for the glasses of the present disclosure. For example, in some aspects, when the glasses herein are ion-exchanged, the ion-exchange does not reach the center of the glass article, and therefore the center of the glass article has the same composition as the starting glass prior to ion-exchange.

In some aspects, disclosed are glass-based articles comprising:
a maximum compressive stress (CS) of at least 300 MPa (e.g., 300-600 MPa);
a depth of layer (DOL) of at least 5 μm (e.g., 5-30 μm); and
a composition at a center of the glass-based article;
wherein a glass-based substrate comprising the composition at the center of the glass-based article and having the same dimensions as the glass-based article comprises any of the glasses disclosed elsewhere herein.

As used herein, the term “wherein a glass-based substrate comprising the composition at the center of the glass-based article and having the same dimensions as the glass-based article comprises any of the glasses disclosed elsewhere herein” and similar such language means that a glass-based substrate that has the same composition as the center of the glass-based article, and which glass-based substrate has the same dimensions as the glass-based article, can be any of the glasses disclosed elsewhere herein. Such a description is relevant to the fact that a glass-based substrate that is ion-exchanged will in some aspects produce a glass-based article that has a composition at its center where ion-exchange has not occurred, such that the composition at the center of the glass-based article is the same as the composition of the glass (glass-based substrate) prior to ion-exchange. In addition, when such a glass (glass-based substrate) prior to IOX has the same dimensions as the resulting ion-exchanged glass-based article, then it can be said that the glass (glass-based substrate) prior to IOX has the Young's modulus specified elsewhere herein for the glasses (e.g., glasses prior to IOX).

In some aspects, the glass-based articles comprise a maximum compressive stress (CS) of at least 300 MPa. In some aspects, the glass-based articles comprise a CS of 600 MPa or less. In some aspects, the CS (MPa) is 300, 325, 350, 375, 400, 425, 450, 475, 500, 525, 550, 575, or 600, in which each of the foregoing numbers can be prefaced with “at least,” “more than,” or “less than,” and in which each of the foregoing numbers can be followed by “or less” or “or more,” so as to create open-ended or closed ranges therefrom. For example, the CS (MPa) can be at least 300, 525 or more, 575 or less, or any range formed from any of the aforementioned numbers, such as 300-600, 300-550, 300-500, 300-450, 300-400, 300-350, 350-600, 350-575, 350-550, 350-500, 350-450, 350-425, 350-400, 400-600, 400-550, 400-525, 400-500, 400-450, 450-600, 450-550, 450-500, 500-600, 500-550, or 550-600. Compressive stress (including surface CS) after ion exchange was measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured at 546.1 nm according to Procedure C (Glass Disc Method) described in ASTM standard C770-16, entitled “Standard Test Method for Measurement of Glass Stress-Optical Coefficient,” hereby incorporated by reference in its entirety for all purposes. As used herein, “compressive stress” (“CS”) refers to the maximum surface compressive stress.

In some aspects, the glass-based articles comprise a depth of layer (DOL) of at least 5 μm. In some aspects, the glass-based articles comprise a DOL of 30 μm or less. In some aspects, the DOL (μm) can be 5, 6, 7, 8, 9, 10, 12, 14, 16, 18, 20, 22, 24, or 25, in which each of the foregoing numbers can be prefaced with “at least,” “more than,” or “less than,” and in which each of the foregoing numbers can be followed by “or less” or “or more,” so as to create open-ended or closed ranges therefrom. For example, the DOL (μm) can be at least 5, more than 8, 10 or more, less than 16, or any range formed from any of the aforementioned numbers, such as 5-30, 5-28, 5-26, 5-24, 5-22, 5-20, 5-18, 5-16, 5-14, 5-12, 5-10, 5-8, 5-6, 6-30, 6-28, 6-26, 6-24, 6-22, 6-20, 6-18, 6-16, 6-14, 6-12, 6-10, 6-8, 8-30, 8-28, 8-26, 8-24, 8-22, 8-20, 8-18, 8-16, 8-14, 8-12, 8-10, 10-30, 10-28, 10-26, 10-24, 10-22, 10-20, 10-18, 10-16, 10-14, 10-12, 12-30, 12-28, 12-26, 12-24, 12-22, 12-20, 12-18, 12-16, 12-14, 14-30, 14-28, 14-26, 14-24, 14-22, 14-20, 14-18, 14-16, 16-30, 16-28, 16-26, 16-24, 16-22, 16-20, 16-18, 18-30, 18-28, 18-26, 18-24, 18-22, 18-20, 20-30, 20-28, 20-26, 20-24, 20-22, 22-30, 22-28, 22-26, 22-24, 24-30, 24-28, 24-26, 26-30, 26-28, or 28-30.

In some aspects, disclosed is a method of chemically strengthening a glass-based substrate, the method comprising:
ion exchanging the glass-based substrate in a molten salt bath to form a glass-based article;
wherein the glass-based article comprises:
   a maximum compressive stress (CS) of at least 300 MPa (e.g., 300-600 MPa); and
   a depth of layer (DOL) of at least 5 μm (e.g., 5-30 μm);
wherein the glass-based substrate comprises any of the glasses disclosed elsewhere herein.

In the method of chemically strengthening a glass-based substrate, the CS and DOL values are the same as described elsewhere for the glass-based article.

In some aspects, in the method of chemically strengthening a glass-based substrate, the ion exchanging step is performed for a suitable time period. For example, in some aspects, the ion exchanging is performed for a time period of 9 hours or less (e.g., 2 hours or less). In some aspects, the ion exchanging is performed for a time period of at least 0.5 hour. In some aspects, the ion exchanging step is performed for a time period (hours) of 0.5, 1, 1.5, 2, 2.5, 3, 3.5, 4, 4.5, 5, 5.5, 6, 6.5, 7, 7.5, 8, 8.5, or 9, in which each of the foregoing numbers can be prefaced with “at least,” “more than,” or “less than,” and in which each of the foregoing numbers can be followed by “or less” or “or more,” so as to create open-ended or closed ranges therefrom. For example, the time period (hours) of ion exchange can be at least 1, 2 or less, less than 1.5, more than 1.5, or any range formed from any of the aforementioned numbers, such as 0.5-9, 0.5-8.5, 0.5-8, 0.5-7.5, 0.5-7, 0.5-6.5, 0.5-6, 0.5-5.5, 0.5-5, 0.5-4.5, 0.5-4, 0.5-3.5, 0.5-3, 0.5-2.5, 0.5-2, 0.5-1.5, 0.5-1, 1-9, 1-8.5, 1-8, 1-7.5, 1-7, 1-6.5, 1-6, 1-5.5, 1-5, 1-4.5, 1-4, 1-3.5, 1-3, 1-2.5, 1-2, 1-1.5, 1.5-9, 1.5-8.5, 1.5-8, 1.5-7.5, 1.5-7, 1.5-6.5, 1.5-6, 1.5-5.5, 1.5-5, 1.5-4.5, 1.5-4, 1.5-3.5, 1.5-3, 1.5-2.5, 1.5-2, 2-9, 2-8.5, 2-8, 2-7.5, 2-7, 2-6.5, 2-6, 2-5.5, 2-5, 2-4.5, 2-4, 2-3.5, 2-3, 2-2.5, 2.5-9, 2.5-8.5, 2.5-8, 2.5-7.5, 2.5-7, 2.5-6.5, 2.5-6, 2.5-5.5, 2.5-5, 2.5-4.5, 2.5-4, 2.5-3.5, 2.5-3, 3-9, 3-8.5, 3-8, 3-7.5, 3-7, 3-6.5, 3-6, 3-5.5, 3-5, 3-4.5, 3-4, 3-3.5, 3.5-9, 3.5-8.5, 3.5-8, 3.5-7.5, 3.5-7, 3.5-6.5, 3.5-6, 3.5-5.5, 3.5-5, 3.5-4.5, 3.5-4, 4-9, 4-8.5, 4-8, 4-7.5, 4-7, 4-6.5, 4-6, 4-5.5, 4-5, 4-4.5, 4.5-9, 4.5-8.5, 4.5-8, 4.5-7.5, 4.5-7, 4.5-6.5, 4.5-6, 4.5-5.5, 4.5-5, 5-9, 5-8.5, 5-8, 5-7.5, 5-7, 5-6.5, 5-6, 5-5.5, 5.5-9, 5.5-8.5, 5.5-8, 5.5-7.5, 5.5-7, 5.5-6.5, 5.5-6, 6-9, 6-8.5, 6-8, 6-7.5, 6-7, 6-6.5, 6.5-9, 6.5-8.5, 6.5-8, 6.5-7.5, 6.5-7, 7-9, 7-8.5, 7-8, 7-7.5, 7.5-8, 8-9, 8-8.5, or 8.5-9.

In some aspects, in the method of chemically strengthening a glass-based substrate, the ion-exchanging step is performed as a single step ion exchange. In some aspects, the ion-exchanging step is performed as a two step ion exchange. In some aspects, multiple ion exchange steps are performed, in which a glass-based substrate is subjected to at least 2, 3, 4, 5, 6, 7, or 8 molten salt baths (each of the salt baths can be the same or different in terms of composition). As should be clear, the number of ion exchange steps means that that number of steps is performed. So, for example, a single step means that one ion exchange step with a molten salt bath is performed, and therefore two or more ion exchange steps with molten salt baths is not included.

In some aspects, the molten salt baths in any step of the ion exchange method can have any suitable composition. For example, in some aspects, any molten salt bath can have a composition of at least 90 wt. % KNO₃. In some aspects, any molten salt bath can have a composition of 100 wt. % (or 100 wt. % or less) KNO₃. In some aspects, any molten salt bath can have a composition (wt. %) of 90, 92, 94, 95, 96, 98, 99, or 100 of KNO₃, in which each of the foregoing numbers can be prefaced with “at least,” “more than,” or “less than,” and in which each of the foregoing numbers can be followed by “or less” or “or more,” so as to create open-ended or closed ranges therefrom. For example, any molten salt bath can have a composition of KNO₃ of at least 95 wt. %, more than 92 wt. %, less than 98 wt. %, or any range formed from any of the aforementioned numbers, such as 90-100, 90-99, 90-98, 90-96, 90-95, 90-94, 90-92, 92-100, 92-99, 92-98, 92-96, 92-95, 92-94, 94-100, 94-99, 94-98, 94-96, 94-95, 95-100, 95-99, 95-98, 95-96, 96-100, 96-99, 96-98, 98-100, 98-99, or 99-100. In such molten salt baths, the balance, if any, can include any standard component of a molten salt bath, such as NaNO₃, K₂CO₃, Na₂CO₃, NaHCO₃, and the like, or any combination thereof.

In some aspects, the ion exchange step(s) in the method is (are) performed at any suitable temperature. For example, in some aspects, the temperature is at least 400° C. In some aspects, the temperature is 500° C. or less. In some aspects, the temperature (° C.) is 400, 410, 420, 430, 440, 450, 460, 470, 480, 490, or 500, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the temperature (° C.) can be at least 430, 450 or less, less than 480, or any range formed from any of the aforementioned numbers, such as 400-500, 400-490, 400-480, 400-470, 400-460, 400-450, 400-440, 400-430, 400-420, 400-410, 410-500, 410-490, 410-480, 410-470, 410-460, 410-450, 410-440, 410-430, 410-420, 420-500, 420-490, 420-480, 420-470, 420-460, 420-450, 420-440, 420-430, 430-500, 430-490, 430-480, 430-470, 430-460, 430-450, 430-440, 440-500, 440-490, 440-480, 440-470, 440-460, 440-450, 450-500, 450-490, 450-480, 450-470, 450-460, 460-500, 460-490, 460-480, 460-470, 470-500, 470-490, 470-480, 480-500, 480-490, or 490-500.

In some aspects, the ion exchange is performed in a single step using a molten salt bath of 100 wt. % KNO₃ at a temperature of 430-450° C., achieving a DOL of at least 8 μm and a CS of 300-600 MPa (e.g., 400-550 MPa). Of course, any molten salt bath composition, temperature, DOL, and CS as disclosed elsewhere herein may be employed/achieved.

Disclosed here is a consumer electronic device comprising:
a housing having a front surface, a back surface, and side surface;
electrical components provided at least partially within the housing, the electrical components including at least a controller, a memory, and a display, the display being provided at or adjacent to a front surface of the housing; and
a cover glass disposed over the display,
wherein at least one of a portion of the housing or the cover glass comprises the glass or glass-based article disclosed elsewhere herein.

In some aspects, the consumer electronic device is a laptop, a computer monitor, a television, a tablet, or a smart phone.

In some aspects, disclosed is a method of recycling glass, the method comprising:
heating a composition to form a melt, the composition comprising:
   glass cullet in an amount of at least 60 wt. %; and
   raw materials in an amount of 40 wt. % or less;
   based on total weight of the composition;
wherein, when the melt is formed and cooled to form a glass-based substrate, the glass-based substrate is any of the glasses disclosed elsewhere herein.

In some aspects, the temperature of the heating step is not particularly limited, but rather is selected so as to melt the composition, as well as to achieve a desired viscosity so as the form the melt using an appropriate glass-forming method, such as fusion, float, and so forth. Accordingly, in some aspects, the temperature can be selected in relation to one or more of the 200 P temperature, 35,000 P temperature, 100,000 P temperature, 200,000 P temperature, liquidus temperature, liquidus viscosity, or any combination thereof. Such temperatures and related considerations such as viscosity, forming methods, and crystallization tendencies, for example, are discussed elsewhere herein.

In some aspects, disclosed is a composition (e.g., employed in the method of recycling glass or as a part of a standalone composition), comprising:
glass cullet in an amount of at least 60 wt. %; and
raw materials in an amount of 40 wt. % or less;
based on total weight of the composition
wherein the glass cullet comprises:
   SiO₂ in an amount of 65-80 wt. %;
   Al₂O₃ in an amount of 1-10 wt. %;
   B₂O₃ in an amount of 5-15 wt. %;
   Na₂O in an amount of 1-10 wt. %;
   K₂O in an amount of 0.1-5;
   CaO in an amount of 0.05-10 wt. %; and
   Li₂O in an amount of less than 0.1 wt. %;
   based on total weight of glass cullet; and
wherein the raw materials comprise at least one of:
   SiO₂;
   Na₂CO₃; and
   Al₂O₃.

In some aspects, the glass cullet is present in the composition (e.g., employed in the method of recycling glass or as a part of a standalone composition) in an amount of at least 60 wt. %. In some aspects, the glass cullet is present in the composition in an amount of 99.5 wt. % or less. In some aspects, the glass cullet is present in the composition in an amount (wt. %) of 60, 65, 70, 75, 80, 85, 90, 95, 97, 99, or 99.5 in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet can be present in the composition in an amount (wt. %) of at least 80, more than 97, 85 or more, 90 or less, or any range formed from any of the aforementioned numbers, such as 60-99.5, 60-99, 60-97, 60-95, 60-90, 60-85, 60-80, 60-75, 60-70, 60-65, 65-99.5, 65-99, 65-97, 65-95, 65-90, 65-85, 65-80, 65-75, 65-70, 70-99.5, 70-99, 70-97, 70-95, 70-90, 70-85, 70-80, 70-75, 75-99.5, 75-99, 75-97, 75-95, 75-90, 75-85, 75-80, 80-99.5, 80-99, 80-97, 80-95, 80-90, 80-85, 85-99.5, 85-99, 85-97, 85-95, 85-90, 90-99.5, 90-99, 90-97, 90-95, 95-99.5, 95-99, 95-97, 97-99.5, 97-99, or 99-99.5.

In some aspects, the raw materials are present in the composition (e.g., employed in the method of recycling glass or as a part of a standalone composition) in a total amount of at least 0.5 wt. %. In some aspects, the raw materials are present in the composition in a total amount of 40 wt. % or less. In some aspects, the raw materials are present in the composition in a total amount (wt. %) of 0.5, 1, 2, 3, 4, 5, 6, 7, 8, 9, 10, 15, 20, 25, 30, 35, or 40, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the raw materials can be present in the composition in a total amount (wt. %) of at least 1, more than 3, 5 or more, 25 or less, or any range formed from any of the aforementioned numbers, such as 0.5-40, 0.5-35, 0.5-30, 0.5-25, 0.5-20, 0.5-15, 0.5-10, 0.5-9, 0.5-8, 0.5-7, 0.5-6, 0.5-5, 0.5-4, 0.5-3, 0.5-2, 0.5-1, 1-40, 1-35, 1-30, 1-25, 1-20, 1-15, 1-10, 1-9, 1-8, 1-7, 1-6, 1-5, 1-4, 1-3, 1-2, 2-40, 2-35, 2-30, 2-25, 2-20, 2-15, 2-10, 2-9, 2-8, 2-7, 2-6, 2-5, 2-4, 2-3, 3-40, 3-35, 3-30, 3-25, 3-20, 3-15, 3-10, 3-9, 3-8, 3-7, 3-6, 3-5, 3-4, 4-40, 4-35, 4-30, 4-25, 4-20, 4-15, 4-10, 4-9, 4-8, 4-7, 4-6, 4-5, 5-40, 5-35, 5-30, 5-25, 5-20, 5-15, 5-10, 5-9, 5-8, 5-7, 5-6, 6-40, 6-35, 6-30, 6-25, 6-20, 6-15, 6-10, 6-9, 6-8, 6-7, 7-40, 7-35, 7-30, 7-25, 7-20, 7-15, 7-10, 7-9, 7-8, 8-40, 8-35, 8-30, 8-25, 8-20, 8-15, 8-10, 8-9, 9-40, 9-35, 9-30, 9-25, 9-20, 9-15, 9-10, 10-40, 10-35, 10-30, 10-25, 10-20, 10-15, 15-40, 15-35, 15-30, 15-25, 15-20, 20-40, 20-35, 20-30, 20-25, 25-40, 25-35, 25-30, 30-40, 30-35, or 35-40. For clarity, such amounts of raw materials is with respect to the total amount of all raw materials present, such as the total amount of one or more of alumina, silica, sodium carbonate, potassium carbonate, and the like.

In some aspects, the glass cullet is present in the composition (e.g., employed in the method of recycling glass or as a part of a standalone composition) in any amount disclosed herein (e.g., at least 80 wt. %) and the raw materials are present in the composition in any amount disclosed herein (e.g., 20 wt. % or less), based on total weight of the composition.

In some aspects, the glass cullet (e.g., employed in the method of recycling or as part of a standalone composition) can comprise one or more of SiO₂, Al₂O₃, B₂O₃, CaO, Li₂O, Na₂O, K₂O. MgO, or any other component described elsewhere herein (e.g., alkali metal oxides, alkaline earth metal oxides, REOs, ZnO, BaO, TiO₂, ZrO₂, SrO, SnO₂, Cl, F, and so forth, or any combination thereof). The descriptions of these components elsewhere herein are equally applicable here.

In some aspects, the glass cullet comprises SiO₂ in amount of at least 65 wt. %. In some aspects, the glass cullet comprises SiO₂ in an amount of 80 wt. % or less. In some aspects, the glass cullet comprises SiO₂ in an amount (wt. %) of 65, 68, 70, 72, 75, 78, or 80, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises SiO₂ in an amount (wt. %) of less than 78, 68 or more, at least 72, or any range formed from any of the aforementioned numbers, such as 65-80, 65-78, 65-75, 65-72, 65-70, 65-68, 68-80, 68-78, 68-75, 68-72, 68-70, 70-80, 70-78, 70-75, 70-72, 72-80, 72-78, 72-75, 75-80, 75-78, or 78-80. In some aspects, the glass cullet is free of, or substantially free of, SiO₂.

In some aspects, the glass cullet comprises Al₂O₃ in amount of at least 1 wt. %. In some aspects, the glass cullet comprises Al₂O₃ in an amount of 10 wt. % or less. In some aspects, the glass cullet comprises Al₂O₃ in an amount (wt. %) of 1, 2, 3, 4, 5, 6, 7, 8, 9, or 10, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises Al₂O₃ in an amount (wt. %) of more than 2, at least 5, less than 9, or any range formed from any of the aforementioned numbers, such as 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3- 8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In some aspects, the glass cullet is free of, or substantially free of, Al₂O₃.

In some aspects, the glass cullet comprises B₂O₃ in amount of at least 5 wt. %. In some aspects, the glass cullet comprises B₂O₃ in an amount of 15 wt. % or less. In some aspects, the glass cullet comprises B₂O₃ in an amount (wt. %) of 5, 6, 7, 8, 9, 10, 11, 12, 13, 14, or 15, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises B₂O₃ in an amount (wt. %) of 13 or less, less than 10, at least 6, or any range formed from any of the aforementioned numbers, such as 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15. In some aspects, the glass cullet is free of, or substantially free of, B₂O₃.

In some aspects, the glass cullet comprises CaO in amount of at least 0.05 wt. %. In some aspects, the glass cullet comprises CaO in an amount of 10 wt. % or less. In some aspects, the glass cullet comprises CaO in an amount (wt. %) of 0.05, 0.1, 0.5, 1, 1.5, 2, 2.5, 3, 3.5, 4, 4.5, 5, 6, 7, 8, 9, or 10, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises CaO in an amount (wt. %) of more than 0.1, at least 0.5, 3 or less, or any range formed from any of the aforementioned numbers, such as 0.05-10, 0.05-9, 0.05-8, 0.05-7, 0.05-6, 0.05-5, 0.05-4, 0.05-3, 0.05-2.5, 0.05-2, 0.05-1.5, 0.05-1, 0.05-0.5, 0.05-0.1, 0.1-10, 0.1-9, 0.1-8, 0.1-7, 0.1-6, 0.1-5, 0.1-4, 0.1-3, 0.1-2.5, 0.1-2, 0.1-1.5, 0.1-1, 0.1-0.5, 0.5-10, 0.5-9, 0.5-8, 0.5-7, 0.5-6, 0.5-5, 0.5-4, 0.5-3, 0.5-2.5, 0.5-2, 0.5-1.5, 0.5-1, 1-10, 1-9, 1-8, 1-7, 1-6, 1-5, 1-4, 1-3, 1-2.5, 1-2, 1-1.5, 1.5-10, 1.5-9, 1.5-8, 1.5-7, 1.5-6, 1.5-5, 1.5-4, 1.5-3, 1.5-2.5, 1.5-2, 2-10, 2-9, 2-8, 2-7, 2-6, 2-5, 2-4, 2-3, 2-2.5, 2.5-10, 2.5-9, 2.5-8, 2.5-7, 2.5-6, 2.5-5, 2.5-4, 2.5-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In some aspects, the glass cullet is free of, or substantially free of, CaO.

In some aspects, the glass cullet is free of or substantially free of Li₂O. For example, in some aspects, the glass cullet comprises Li₂O in an amount (wt. %) of less than any of the following amounts: 1, 0.9, 0.8, 0.7, 0.6, 0.5, 0.4, 0.3, 0.2, 0.1, 0.08, 0.06, 0.04, 0.02, or 0.01. In some aspects, the glasses disclosed herein comprise Li₂O in an amount (wt. %) of less than 0.5 wt. % or less than 0.1 wt. %. In some aspects, the glasses disclosed herein comprise Li₂O in an amount (wt. %) of 0.01, 0.02, 0.04, 0.06, 0.08, 0.1, 0.2, 0.3, 0.4, 0.5, 0.6, 0.7, 0.8, 0.9, or 1, in which each of the foregoing numbers can be prefaced with “at least,” “more than,” or “less than,” and in which each of the foregoing numbers can be followed by “or less” or “or more,” so as to create open-ended or closed ranges therefrom. For example, the glasses disclosed herein comprise Li₂O in an amount (wt. %) of 0.4 or less, less than 0.08, at least 0.01, or any range formed from any of the aforementioned numbers, such as 0.01-1, 0.01-0.8, 0.01-0.6, 0.01-0.4, 0.01-0.2, 0.01-0.1, 0.01-0.05, 0.05-1, 0.05-0.8, 0.05-0.6, 0.05-0.4, 0.05-0.2, 0.05-0.1, 0.1-1, 0.1-0.8, 0.1-0.6, 0.1-0.4, 0.1-0.2, 0.2-1, 0.2-0.8, 0.2-0.6, 0.2-0.4, 0.4-1, 0.4-0.8, 0.4-0.6, 0.6-1, 0.6-0.8, or 0.8-1.

In some aspects, the glass cullet comprises Na₂O in amount of at least 1 wt. %. In some aspects, the glass cullet comprises Na₂O in an amount of 10 wt. % or less. In some aspects, the glass cullet comprises Na₂O in an amount (wt. %) of 1, 2, 3, 4, 5, 6, 7, 8, 9, or 10, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises Na₂O in an amount (wt. %) of at least 3, 8 or less, less than 5, more than 2, or any range formed from any of the aforementioned numbers, such as 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10.

In some aspects, the glass cullet comprises K₂O in amount of at least 0.1 wt. %. In some aspects, the glass cullet comprises K₂O in an amount of 5 wt. % or less. In some aspects, the glass cullet comprises K₂O in an amount (wt. %) of 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises K₂O in an amount (wt. %) of 1.5 or more, at least 0.5, less than 3.5, 2.5 or less, or any range formed from any of the aforementioned numbers, such as 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-0.5, 3-4, 3-3.5, 3.5-5, 3.5-4.5, 3.5-4, 4-5, 4-4.5, or 4.5-5.

In some aspects, the glass cullet comprises MgO in amount of 0 wt. % or >0 wt. %. In some aspects, the glass cullet comprises MgO in an amount of 5 wt. % or less. In some aspects, the glass cullet comprises MgO in an amount (wt. %) of 0, >0, 0.1, 0.5, 1, 1.5, 2, 2.5, 3, 3.5, 4, 4.5, or 5, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises MgO in an amount (wt. %) of 0.1 or more, 3 or less, less than 1.5, or any range formed from any of the aforementioned numbers, such as 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5.

In some aspects, the glass cullet comprises Cl (interchangeably referred to herein as Cl or Cl) in amount of 0 wt. % or >0 wt. %. In some aspects, the glass cullet comprises MgO in an amount of 2 wt. % or less. In some aspects, the glass cullet comprises Cl in an amount (wt. %) of 0, >0, 0.1, 0.2, 0.4, 0.6, 0.8, 1, 1.2, 1.4, 1.6, 1.8, or 2 in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises Cl in an amount (wt. %) of less than 0.4, 0.8 or less, at least 0.1, more than 0.2, or any range formed from any of the aforementioned numbers, such as 0-2, 0-1.8, 0-1.6, 0-1.4, 0-1.2, 0-1, 0-0.8, 0-0.6, 0-0.4, 0-0.2, 0-0.1, >0-2, >0-1.8, >0-1.6, >0-1.4, >0-1.2, >0-1, >0-0.8, >0-0.6, >0-0.4, >0-0.2, >0-0.1, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-2, 0.2-1.8, 0.2-1.6, 0.2-1.4, 0.2-1.2, 0.2-1, 0.2-0.8, 0.2-0.6, 0.2-0.4, 0.4-2, 0.4-1.8, 0.4-1.6, 0.4-1.4, 0.4-1.2, 0.4-1, 0.4-0.8, 0.4-0.6, 0.6-2, 0.6-1.8, 0.6-1.6, 0.6-1.4, 0.6-1.2, 0.6-1, 0.6-0.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2.

In some aspects, the glass cullet comprises F (interchangeably referred to herein as F or F) in amount of 0 wt. % or >0 wt. %. In some aspects, the glass cullet comprises F in an amount of 2 wt. % or less. In some aspects, the glass cullet comprises F in an amount (wt. %) of 0, >0, 0.1, 0.2, 0.4, 0.6, 0.8, 1, 1.2, 1.4, 1.6, 1.8, or 2, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects the glass cullet comprises F in an amount (wt. %) of more than 0.2, less than 0.6, 0.1 or less, or any range formed from any of the aforementioned numbers, such as 0-2, 0-1.8, 0-1.6, 0-1.4, 0-1.2, 0-1, 0-0.8, 0-0.6, 0-0.4, 0-0.2, 0-0.1, >0-2, >0-1.8, >0-1.6, >0-1.4, >0-1.2, >0-1, >0-0.8, >0-0.6, >0-0.4, >0-0.2, >0-0.1, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-2, 0.2-1.8, 0.2-1.6, 0.2-1.4, 0.2-1.2, 0.2-1, 0.2-0.8, 0.2-0.6, 0.2-0.4, 0.4-2, 0.4-1.8, 0.4-1.6, 0.4-1.4, 0.4-1.2, 0.4-1, 0.4-0.8, 0.4-0.6, 0.6-2, 0.6-1.8, 0.6-1.6, 0.6-1.4, 0.6-1.2, 0.6-1, 0.6-0.8, 0.8-2, 0.8-1.8, 0.8-1.6, 0.8-1.4, 0.8-1.2, 0.8-1, 1-2, 1-1.8, 1-1.6, 1-1.4, 1-1.2, 1.2-2, 1.2-1.8, 1.2-1.6, 1.2-1.4, 1.4-2, 1.4-1.8, 1.4-1.6, 1.6-2, 1.6-1.8, or 1.8-2.

In some aspects, the composition (e.g., employed in the method of recycling glass or as a part of a standalone composition) comprises glass cullet and raw materials. The glass cullet is described elsewhere herein. In some aspects, the raw materials comprise any suitable components that can be combined with glass cullet. In some aspects, the raw materials supply elements or compounds that are not present, or present in insufficient amounts, in the glass cullet, so as to result in a glass that has a desired composition and/or one or more desired properties (e.g., as described elsewhere herein). In some aspects, the raw materials comprise at least one of SiO₂, Na₂CO₃, Al₂O₃, B₂O₃, Na₂B₄O₇, NaNO₃, MgO, CaCO₃, Sr(NO₃)₂, SrCO₃, Ba(NO₃)₂, BaCO₃, SnO, ZnO, CaF₂, CaCl₂), and BaF₂ . . . . In some aspects, the raw materials comprise SiO₂. In some aspects, the raw materials comprise Na₂CO₃. In some aspects, the raw materials comprise Al₂O₃. In some aspects, the raw materials comprise at least one of SiO₂, Na₂CO₃, and Al₂O₃. In some aspects, the raw materials comprise SiO₂ and Na₂CO₃. In some aspects, the raw materials comprise Na₂CO₃ and Al₂O₃. In some aspects, the raw materials comprise SiO₂ and Al₂O₃. In some aspects, the raw materials comprise SiO₂, Na₂CO₃, and Al₂O₃.

In some aspects, the composition (e.g., employed in the method of recycling glass or as a part of a standalone composition) comprises any individual component, such as SiO₂, Na₂CO₃, Al₂O₃, B₂O₃, Na₂B₄O₇, NaNO₃, MgO, CaCO₃, Sr(NO₃)₂, SrCO₃, Ba(NO₃)₂, BaCO₃, SnO, ZnO, CaF₂, CaCl₂), or BaF₂, in an amount of 0 wt. % or >0 wt. %. In some aspects, the composition comprises any individual component, such as SiO₂, Na₂CO₃, Al₂O₃, B₂O₃, Na₂B₄O₇, NaNO₃, MgO, CaCO₃, Sr(NO₃)₂, SrCO₃, Ba(NO₃)₂, BaCO₃, SnO, ZnO, CaF₂, CaCl₂), or BaF₂, in an amount of 15 wt. % or less. In some aspects, the composition comprises any of such individual components in an amount (wt. %) of 0, >0, 1, 2, 4, 5, 6, 8, 9, 10, 11, 12, 13, or 14, or 15, in which each of the foregoing numbers can be prefaced with “at least,” “more than,” or “less than,” and in which each of the foregoing numbers can be followed by “or less” or “or more,” so as to create open-ended or closed ranges therefrom. For example, in some aspects, the composition comprises any of such individual components in an amount (wt. %) of at least 2, less than 10, 8 or less, more than 4, 14 or less, or any range formed from any of the aforementioned numbers, such as 0-15, 0-14, 0-13, 0-12, 0-11, 0-10, 0-9, 0-8, 0-7, 0-6, 0-5, 0-4, 0-3, 0-2, 0-1, >0-15, >0-14, >0-13, >0-12, >0-11, >0-10, >0-9, >0-8, >0-7, >0-6, >0-5, >0-4, >0-3, >0-2, >0-1, 1-15, 1-14, 1-13, 1-12, 1-11, 1-0, 1-9, 1-8, 1-7, 1-6, 1-5, 1-4, 1-3, 1-2, 2-15, 2-14, 2-13, 2-12, 2-11, 2-10, 2-9, 2-8, 2-7, 2-6, 2-5, 2-4, 2-3, 3-15, 3-14, 3-13, 3-12, 3-11, 3-10, 3-9, 3-8, 3-7, 3-6, 3-5, 3-4, 4-15, 4-14, 4-13, 4-12, 4-11, 4-10, 4-9, 4-8, 4-7, 4-6, 4-5, 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15, based on total weight of the composition. So, for example, in some aspects the composition comprises raw materials comprising Na₂CO₃ in any amount herein, such as >0-10 wt. %, based on total weight of the composition. In some aspects, the composition comprises raw materials comprising SiO₂ in any amount herein, such as >0-10 wt. %, based on total weight of the composition. In some aspects, the composition comprises raw materials comprising Al₂O₃ in any amount herein, such as >0-10 wt. %, based on total weight of the composition. Any of such numbers applies to any individual component of the raw materials. For clarity, any one or more of the components of the raw materials can be employed in combination in the composition, and any of such numbers may be used to described the amount of any such individual component even when such components are used in combination. In some aspects, the raw materials are free of, or substantially free of, any one or more of the following: SiO₂, Na₂CO₃, Al₂O₃, B2O₃, Na₂B₄O₇, NaNO₃, MgO, CaCO₃, Sr(NO₃)₂, SrCO₃, Ba(NO₃)₂, BaCO₃, SnO, ZnO, CaF₂, CaCl₂), or BaF₂.

In some aspects, the composition comprises glass cullet in any amount disclosed herein, such as an amount of 85-99 wt. %, based on total weight of the composition, and any raw materials in any amount disclosed elsewhere herein, such as raw materials comprising at least one of: Na₂CO₃ in an amount of >0-10 wt. %; SiO₂ in an amount of >0-10 wt. %; and Al₂O₃ in an amount of >0-10 wt. %; based on total weight of the composition.

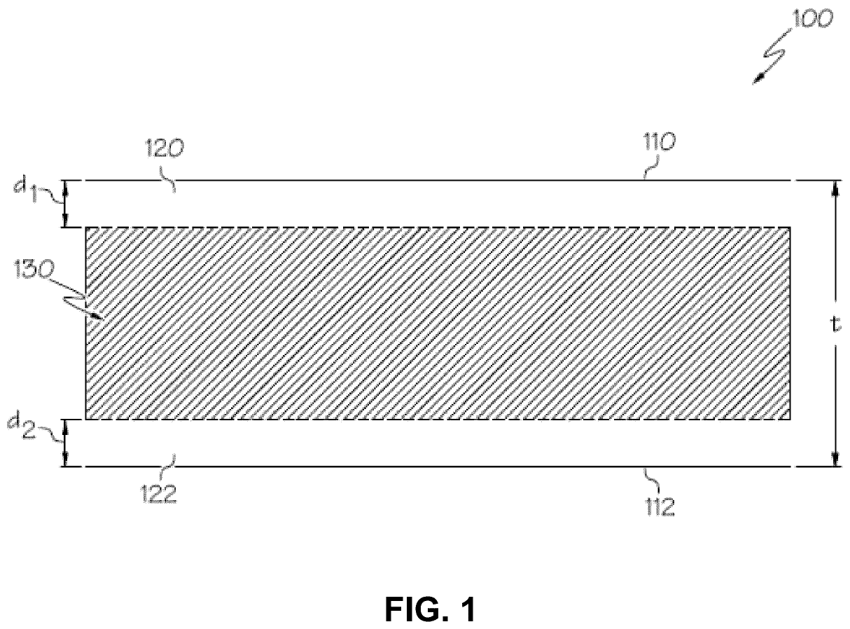

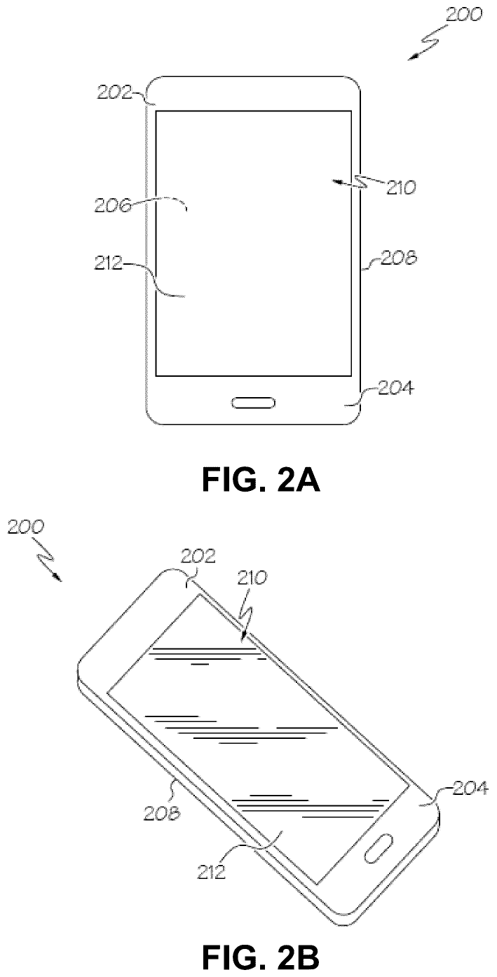

Aspects of the disclosure will now be discussed with reference to FIGS. 1, 2A, and 2B, which illustrate various aspects of the disclosure herein. The following general description is intended to provide an overview of the disclosure and structures, and various aspects will be more specifically discussed throughout the disclosure with reference to the non-limiting depicted aspects, all of these aspects being interchangeable and combinable with one another within the context of the disclosure.

In some aspects, the glasses described herein can be strengthened, such as by ion exchange, making a glass-based article that is damage resistant for applications such as, but not limited to, display covers. With reference to FIG. 1, a glass-based article 100 is depicted that has a first region under compressive stress (e.g., first and second compressive layers 120, 122 in FIG. 1) extending from the surface to a depth of compression (DOC) of the glass-based article and a second region (e.g., central region 130 in FIG. 1) under a tensile stress or central tension (CT) extending from the DOC into the central or interior region of the glass-based article. As used herein, DOC refers to the depth at which the stress within the glass-based article changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the glass-based article, and the CS varies with distance d from the surface according to a function. Referring again to FIG. 1, a first segment 120 extends from first surface 110 to a depth d₁ and a second segment 122 extends from second surface 112 to a depth d₂. Together, these segments define a compression or CS of glass-based article 100. Compressive stress (including surface CS) may be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

In some aspects, Na⁺ and K⁺ ions are exchanged into the glass-based article and the Na⁺ ions diffuse to a deeper depth into the glass-based article than the K⁺ ions. The depth of penetration of K⁺ ions (“Potassium DOL”) is distinguished from DOC because it represents the depth of potassium penetration as a result of an ion exchange process. The Potassium DOL is typically less than the DOC for the articles described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL_{SP}), where a stress profile transitions from a steep spike region to a less-steep deep region. The deep region extends from the bottom of the spike to the depth of compression.

The compressive stress of both major surfaces (110, 112 in FIG. 1) is balanced by stored tension in the central region (130) of the glass-based article. The maximum central tension (CT) and DOC values may be measured using a scattered light polariscope (SCALP) technique known in the art. The refracted near-field (RNF) method or SCALP may be used to determine the stress profile of the glass-based articles. When the RNF method is utilized to measure the stress profile, the maximum CT value provided by SCALP is utilized in the RNF method. In particular, the stress profile determined by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

The measurement of a maximum CT value is an indicator of the total amount of stress stored in the strengthened articles, due to the force balancing described above. For this reason, the ability to achieve higher CT values correlates to the ability to achieve higher degrees of strengthening and increased performance. In some aspects, the glass-based articles may have a maximum CT greater than or equal to 60 MPa, such as greater than or equal to 100 MPa, such as greater than or equal to 120 MPa, greater than or equal to 140 MPa, greater than or equal to 160 MPa, greater than or equal to 180 MPa, or more. In some aspects, the glass-based article may have a maximum CT of from greater than or equal to 60 MPa to less than or equal to 1.5 GPa, and all ranges and sub-ranges between the foregoing values in this paragraph.

As noted above, DOC is measured using a scattered light polariscope (SCALP) technique known in the art. The DOC may be provided as a portion of the thickness (t) of the glass-based article.

The ion-exchange conditions disclosed herein were not necessarily optimized for the glass compositions disclosed herein. As such, the data demonstrates that IOX is effective for these compositions and provides some examples of parameters that can be achieved. However, it is expected based on the disclosure herein that other parameters may be achieved, as desired, such as higher CT.

Thickness (t) of glass-based article 100 is measured between surface 110 and surface 112. In some aspects, the thickness of glass-based article 100 may be in a range from greater than or equal to 0.1 mm to less than or equal to 4 mm, such as greater than or equal to 0.2 mm to less than or equal to 3.5 mm, greater than or equal to 0.3 mm to less than or equal to 3 mm, greater than or equal to 0.4 mm to less than or equal to 2.5 mm, greater than or equal to 0.5 mm to less than or equal to 2 mm, greater than or equal to 0.6 mm to less than or equal to 1.5 mm, greater than or equal to 0.7 mm to less than or equal to 1 mm, greater than or equal to 0.2 mm to less than or equal to 2 mm, and all ranges and sub-ranges between the foregoing values. The glass substrate utilized to form the glass-based article may have the same thickness as the thickness desired for the glass-based article. More generally, any thickness suitable for a glass-based article or glass may be used. Such thicknesses may be outside the ranges discussed in this paragraph or elsewhere herein. For clarity, any of the thicknesses disclosed herein can be applied to glasses or glass-based articles.

The glass-based articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, other applications disclosed elsewhere herein, or any article that requires some transparency, scratch-resistance, abrasion resistance or a combination thereof. An exemplary article incorporating any of the glass-based articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In some aspects, at least a portion of at least one of the cover 212 and the housing 202 may include any of the glass-based articles described herein. In some aspects, the glass-based articles disclosed herein are cover glasses.

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein. Any reference to “Aspect 1” is intended to include any aspect of the same number that also includes a letter (e.g., Aspect 1A, Aspect 1B, etc.).

Aspect 1A: A glass, comprising:
SiO₂ in an amount of 64-73 wt. %;
Al₂O₃ in an amount of 7-15 wt. %;
B₂O₃ in an amount of 9-11 wt. %;
Na₂O in an amount of 6-9.5 wt. %;
K₂O in an amount of 0.5-3 wt. %; and
CaO in an amount of at least 0.05 wt. %;
Li₂O in an amount of 0.1 wt. % or less;
wherein a weight ratio of Na₂O/Al₂O₃ is less than or equal to 0.9.

Aspect 1B: A glass (e.g., an aluminoborosilicate glass, alkali aluminoborosilicate glass, etc.), comprising at least one of (e.g., or all of):
a coefficient of thermal expansion (CTE) of 70×10⁻⁷/° C. or less;
a liquidus viscosity of at least 150 kP; and
Li₂O in an amount of 0.1 wt. % or less;
wherein the glass is ion-exchangeable.

Aspect 2: The glass of any preceding aspect, or any other aspect herein, comprising:
SiO₂ in an amount of 66-72 wt. %;
Al₂O₃ in an amount of 8-14 wt. %;
Na₂O in an amount of 6.5-9 wt. %;
K₂O in an amount of 1-2.5 wt. %; and
CaO in an amount of 0.1-5 wt. %;
Aspect 3: The glass of any preceding aspect, or any other aspect herein, comprising:
CaO in an amount of 0.1-2 wt. %
MgO in an amount of 0-1 wt. %; and
SnO₂ in an amount of 0-1 wt. %.

Aspect 4: The glass of any preceding aspect, or any other aspect herein, comprising at least one of:
a coefficient of thermal expansion (CTE) of 70×10⁻⁷/° C. or less; and
a liquidus viscosity of at least 150 kP.

Aspect 5: The glass of any preceding aspect, or any other aspect herein, wherein the Young's modulus is at least 60 GPa.

Aspect 6: The glass of any preceding aspect, or any other aspect herein, wherein the CTE is at least 44×10⁻⁷/° C.

Aspect 7: The glass of any preceding aspect, or any other aspect herein, comprising a 200 P temperature of 1800° C. or less.

Aspect 8: The glass of any preceding aspect, or any other aspect herein, comprising a 35,000 P temperature of at least 1000° C.

Aspect 9: The glass of any preceding aspect, or any other aspect herein, comprising a strain point of at least 525° C.

Aspect 10: The glass of any preceding aspect, or any other aspect herein, comprising a liquidus temperature of 1000° C. or less.

Aspect 11: The glass of any preceding aspect, or any other aspect herein, comprising a liquidus viscosity of 18,000 kP or less.

Aspect 12: The glass of any preceding aspect, or any other aspect herein, wherein, when the glass has a thickness of 1 mm and is subjected to a single step ion exchange in a 100 wt. % KNO₃ molten salt bath at 430-450° C., the glass achieves a maximum compressive stress of 300-600 MPa and a depth of layer (DOL) of at least 8 μm within 1 hour.

Aspect 13: The glass of any preceding aspect, or any other aspect herein, wherein the glass is substantially free of Li₂O.

Aspect 14: A method of chemically strengthening a glass-based substrate, the method comprising:
ion exchanging the glass-based substrate in a molten salt bath to form a glass-based article;
wherein the glass-based article comprises:
   a maximum compressive stress (CS) of 300-600 MPa; and
   a depth of layer (DOL) of 5-30 μm;
wherein the glass-based substrate comprises the glass of any preceding claim.

Aspect 15: The method of aspect 14, any preceding aspect, or any other aspect herein, wherein the ion-exchanging takes place for 2 hours or less.

Aspect 16: The method of aspect 14 or 15, wherein the ion-exchanging is a single-step ion-exchange.

Aspect 17: The method of any one of claims 14-16, any preceding aspect, or any other aspect herein, wherein the molten salt bath comprises at least 95 wt. % KNO₃ and a temperature of at least 400° C.

Aspect 18: A glass-based article, comprising:
a maximum compressive stress (CS) of 300-600 MPa;
a depth of layer (DOL) of 5-30 μm; and
a composition at a center of the glass-based article;
wherein the composition at the center of the glass-based article comprises the glass of any one of aspects 1-13, any preceding aspect, or any other aspect herein.

Aspect 19: A consumer electronic device comprising:
a housing having a front surface, a back surface, and side surface;
electrical components provided at least partially within the housing, the electrical components including at least a controller, a memory, and a display, the display being provided at or adjacent to a front surface of the housing; and
a cover glass disposed over the display,
wherein at least one of a portion of the housing or the cover glass comprises the glass or glass-based article of any preceding aspect, or any other aspect herein.

Aspect 20: The consumer electronic device of aspect 19, any preceding aspect, or any other aspect herein, wherein the consumer electronic device is a laptop, a computer monitor, a television, a tablet, or a smart phone.

Aspect 21: A method of recycling glass, the method comprising:
heating a composition to form a melt, the composition comprising:
   glass cullet in an amount of at least 60 wt. %; and
   raw materials in an amount of 40 wt. % or less;
   based on total weight of the composition;
wherein, when the melt is formed and cooled to form a glass-based substrate, the glass-based substrate is the glass of any one of aspects 1-13, any preceding aspect, or any other aspect herein.

Aspect 22: The method of aspect 21, any preceding aspect, or any other aspect herein, wherein the glass cullet is present in an amount of at least 80 wt. % and the raw materials are present in an amount of 20 wt. % or less, based on total weight of the composition.

Aspect 23: The method of aspect 21 or 22, any preceding aspect, or any other aspect herein, wherein the glass cullet comprises:
SiO₂ in an amount of 65-80 wt. %;
Al₂O₃ in an amount of 1-10 wt. %;
B₂O₃ in an amount of 5-15 wt. %;
Na₂O in an amount of 1-10 wt. %;
K₂O in an amount of 0.1-5;
CaO in an amount of 0.05-10 wt. %; and
Li₂O in an amount of less than 0.1 wt. %;
based on total weight of glass cullet.

Aspect 24: The method of aspect 23, any preceding aspect, or any other aspect herein, wherein the glass cullet further comprises:
MgO in an amount of 0-5 wt. %;
Cl in an amount of 0-2 wt. %; and
F in an amount of 0-2 wt. %;
based on total weight of glass cullet.

Aspect 25: The method of any one of aspects 21-24, any preceding aspect, or any other aspect herein, wherein the glass cullet is substantially free of Li₂O.

Aspect 26: The method of any one of aspects 21-25, any preceding aspect, or any other aspect herein, wherein the raw materials comprise at least one of:
SiO₂;
Na₂CO₃; and
Al₂O₃.

Aspect 27: The method of any one of aspects 21-26, any preceding aspect, or any other aspect herein, wherein the composition comprises:
glass cullet in an amount of 85-99 wt. %, based on total weight of the composition; and
raw materials comprising at least one of:
   Na₂CO₃ in an amount of >0-10 wt. %;
   SiO₂ in an amount of >0-10 wt. %; and
   Al₂O₃ in an amount of >0-10 wt. %;
   based on total weight of the composition.

Aspect 28: A composition, comprising:
glass cullet in an amount of at least 60 wt. %; and
raw materials in an amount of 40 wt. % or less;
based on total weight of the composition
wherein the glass cullet comprises:
   SiO₂ in an amount of 65-80 wt. %;
   Al₂O₃ in an amount of 1-10 wt. %;
   B₂O₃ in an amount of 5-15 wt. %;
   Na₂O in an amount of 1-10 wt. %;
   K₂O in an amount of 0.1-5;
   CaO in an amount of 0.05-10 wt. %; and
   Li₂O in an amount of less than 0.1 wt. %;
   based on total weight of glass cullet; and
wherein the raw materials comprise at least one of:
   SiO₂;
   Na₂CO₃; and
   Al₂O₃.

Aspect 29: The composition of aspect 28, any preceding aspect, or any other aspect herein, wherein the glass cullet is present in an amount of at least 80 wt. % and the raw materials are present in an amount of 20 wt. % or less, based on total weight of the composition.

Aspect 30: The composition of aspect 28 or 29, any preceding aspect, or any other aspect herein, wherein the glass cullet further comprises:
MgO in an amount of 0-5 wt. %;
Cl in an amount of 0-2 wt. %; and
F in an amount of 0-2 wt. %;
based on total weight of glass cullet.

Aspect 31: The composition of any one of aspects 28-30, any preceding aspect, or any other aspect herein, wherein the glass cullet is substantially free of Li₂O.

Aspect 32: The composition of any one of aspects 28-31, any preceding aspect, or any other aspect herein, comprising:
glass cullet in an amount of 85-99 wt. %, based on total weight of the composition; and
at least one of:
   Na₂CO₃ in an amount of 0-10 wt. %;
   SiO₂ in an amount of 0-10 wt. %; and
   Al₂O₃ in an amount of 0-10 wt. %;
   based on total weight of the composition.

Aspect 33: A combination of any two or more preceding aspects or any portion(s) thereof.

### EXAMPLES

The following examples illustrate non-limiting aspects of the disclosure and are not intended to be limiting on the scope of the disclosure or claims.

### Example 1

This example demonstrates the production of glasses using glass cullet as a recycled component in combination with raw materials.

Glass cullet having a composition comprising SiO₂ in an amount of 65-80 wt. %, Al₂O₃ in an amount of 1-10 wt. %, B₂O₃ in an amount of 5-15 wt. %, Na₂O in an amount of 1-10 wt. %, K₂O in an amount of 0.1-5, CaO in an amount of 0.05-10 wt. %, Li₂O in an amount of less than 0.1 wt. %, MgO in an amount of 0-5 wt. %, Cl in an amount of 0-2 wt. %, and F in an amount of 0-2 wt. %, based on total weight of glass cullet, can be recycled in accordance with the disclosures herein. To demonstrate the recycling of such glasses, glass cullet having Composition A set forth in Table 1 below is illustrative.

TABLE 1
Composition A

| Component | Amount (wt. %) |
|---|---|
| SiO₂ | 72.62 |
| Al₂O₃ | 6.63 |
| B₂O₃ | 10.99 |
| Na₂O | 6.67 |
| K₂O | 1.22 |
| MgO | 0.02 |
| CaO | 1.24 |
| Cl | 0.03 |
| F | 0.24 |

In this example, glass cullet was produced from a glass having Composition A by crushing the glass to an average size of about 0.64 cm (about 0.25 inches). The glass cullet was then subjected to magnets to remove any magnetic metals that may be present in the glass cullet (e.g., from the crushing equipment). The glass cullet may be washed if needed or desired to remove foreign matter.

The glass cullet having Composition A was then combined with raw materials, including SiO₂, Na₂CO₃, and/or Al₂O₃, in the amounts shown Table 2, followed by mixing for 15 minutes in a TURBULA mixer.

TABLE 2
Mixtures of Glass Cullet and Raw Materials Prior to Melting

| | E1 | E2 | E3 | E4 | E5 | E6 | E7 | E8 | E9 | E10 |
|---|---|---|---|---|---|---|---|---|---|---|
| | wt. % | | | | | | | | | |
| Cullet | 98.4 | 96.8 | 95.2 | 92.0 | 92.0 | 92.1 | 92.1 | 90.2 | 89.3 | 88.3 |
| SiO₂ | | | | | | | | 1.8 | 2.8 | 3.7 |
| Na₂CO₃ | | | | 4.1 | 3.3 | 2.4 | 1.6 | 3.3 | 3.3 | 3.3 |
| Al₂O₃ | 1.6 | 3.2 | 4.8 | 3.9 | 4.7 | 5.5 | 6.3 | 4.7 | 4.7 | 4.7 |

| | E11 | E12 | E13 | E14 | E15 | E16 | E17 | E18 | E19 |
|---|---|---|---|---|---|---|---|---|---|
| | wt. % | | | | | | | | |
| Cullet | 90.5 | 89.0 | 87.5 | 89.7 | 88.2 | 86.8 | 86.1 | 86.8 | 85.3 |
| SiO₂ | | | | | | | | | |
| Na₂CO₃ | 4.9 | 4.8 | 4.8 | 5.6 | 5.6 | 5.6 | 4.8 | 4.8 | 5.5 |
| Al₂O₃ | 4.7 | 6.2 | 7.7 | 4.7 | 6.2 | 7.7 | 9.2 | 8.4 | 9.1 |

The mixtures of glass cullet and raw materials shown in Table 2 were melted above the liquidus temperature of each resulting glass, and optionally heated to around the 200 P temperature of each resulting glass, followed by forming into 1 mm thick glasses. The resulting glasses have the composition and properties shown in Table 3.

TABLE 3
Composition and Properties of Glasses Formed from Mixtures in Table 2

| wt. % | | E1 | E2 | E3 | E4 | E5 | E6 | E7 | E8 |
|---|---|---|---|---|---|---|---|---|---|
| SiO₂ | | 72.12 | 71.07 | 69.78 | 68.99 | 68.76 | 68.39 | 68.31 | 69.21 |
| Al₂O₃ | | 7.85 | 9.27 | 10.78 | 9.99 | 10.78 | 11.50 | 12.04 | 10.66 |
| B₂O₃ | | 10.66 | 10.53 | 10.35 | 10.04 | 9.88 | 9.94 | 9.99 | 9.74 |
| Na₂O | | 6.64 | 6.45 | 6.41 | 8.42 | 8.03 | 7.59 | 7.09 | 7.90 |
| K₂O | | 1.63 | 1.58 | 1.60 | 1.47 | 1.48 | 1.51 | 1.51 | 1.44 |
| MgO | | 0.03 | 0.03 | 0.03 | 0.03 | 0.03 | 0.03 | 0.03 | 0.03 |
| CaO | | 1.07 | 1.07 | 1.04 | 1.04 | 1.03 | 1.03 | 1.03 | 1.01 |
| SnO₂ | | 0.01 | 0.01 | 0.01 | 0.01 | 0.00 | 0.01 | 0.00 | 0.00 |
| density (g/cm³) | | 2.328 | 2.318 | 2.308 | 2.363 | 2.342 | 2.332 | 2.319 | 2.34 |
| CTE (×10⁻⁷) | | 52.7 | 53.1 | 53.5 | 61.8 | 58.9 | 58.2 | 56.1 | 58.8 |
| Strain Point (° C.) | | 534 | 527 | 533 | 536 | 540 | 535 | 534 | 540 |
| annealing Point (° C.) | | 576 | 573 | 579 | 578 | 582 | 580 | 581 | 584 |
| softening Point (° C.) | | 794.5 | 800.9 | 821.6 | 776.8 | 802.6 | 808.4 | 828.4 | 801.7 |
| RI @ 589.3 nm | | 1.489 | 1.488 | 1.486 | 1.495 | 1.492 | 1.490 | 1.488 | 1.491 |
| SOC (nm/mm/MPa) | | 3.473 | 3.556 | 3.652 | 3.361 | 3.447 | 3.533 | 3.475 | 3.629 |
| Poisson's Ratio | | 0.194 | 0.198 | 0.201 | 0.198 | 0.202 | 0.203 | 0.204 | 0.2 |
| shear modulus (GPa) | | 28.8 | 27.9 | 27.0 | 29.4 | 28.5 | 27.9 | 26.9 | 28.5 |
| Young's modulus (GPa) | | 68.8 | 66.9 | 65.0 | 70.5 | 68.5 | 67.0 | 64.7 | 68.5 |
| VFT | A | −1.441 | −1.786 | −1.976 | −1.054 | −1.361 | −2.722 | −2.448 | −1.727 |
| parameters | B | 5757.7 | 6820 | 7568.8 | 4658.4 | 5581.1 | 9156.0 | 8786.9 | 6524.5 |
| | T₀ | 148 | 51.2 | 18.8 | 224.8 | 148.4 | −111.6 | −80.8 | 71.6 |

| | | | | | | | | |
|---|---|---|---|---|---|---|---|---|
| 200 P temp (° C.) | 1687 | 1720 | 1788 | 1613 | 1672 | 1711 | 1769 | 1691 |
| 35000 P temp (° C.) | 1110 | 1129 | 1180 | 1057 | 1094 | 1149 | 1176 | 1112 |
| 100000 P temp (° C.) | 1042 | 1056 | 1104 | 994 | 1026 | 1074 | 1099 | 1041 |
| 200000 P temp (° C.) | 1002 | 1014 | 1059 | 958 | 986 | 1030 | 1053 | 1000 |
| Liquidus Temp (° C.) | 910 | <840 | <890 | <895 | 815 | <825 | 895 | 805 |
| Liquidus viscosity | 1,303 | >7,245 | >5,150 | >788 | 10,268 | >11,318 | 3,604 | 14,765 |
| (Kilo poise) | | | | | | | | |

| wt. % | | E9 | E10 | E11 | E12 | E13 | E14 | E15 | E16 |
|---|---|---|---|---|---|---|---|---|---|
| SiO₂ | | 69.53 | 69.68 | 68.11 | 66.69 | 65.97 | 68.09 | 66.62 | 65.57 |
| Al₂O₃ | | 10.65 | 10.56 | 10.74 | 12.16 | 13.51 | 10.76 | 12.22 | 13.57 |
| B₂O₃ | | 9.53 | 9.50 | 9.74 | 9.82 | 9.37 | 9.53 | 9.62 | 9.38 |
| Na₂O | | 7.82 | 7.80 | 8.90 | 8.82 | 8.68 | 9.14 | 9.10 | 9.05 |
| K₂O | | 1.42 | 1.43 | 1.45 | 1.47 | 1.44 | 1.41 | 1.39 | 1.41 |
| MgO | | 0.03 | 0.03 | 0.03 | 0.03 | 0.03 | 0.03 | 0.03 | 0.03 |
| CaO | | 1.01 | 0.99 | 1.01 | 1.00 | 0.99 | 1.03 | 1.01 | 0.99 |
| SnO₂ | | 0.00 | 0.00 | 0.00 | 0.00 | 0.00 | 0.00 | 0.00 | 0.00 |
| density (g/cm³) | | 2.34 | 2.341 | 2.364 | 2.354 | 2.346 | 2.372 | 2.363 | 2.356 |
| CTE (×10⁻⁷) | | 58 | 58 | 62.6 | 62.7 | 62.9 | 64.3 | 64.2 | 64 |
| Strain Point (° C.) | | 539 | 538 | 538 | 539 | 537 | 541 | 541 | 537 |
| annealing Point (° C.) | | 584 | 583 | 578 | 580 | 581 | 581 | 582 | 580 |
| softening Point (° C.) | | 807.2 | 806 | 781.4 | 795.5 | 809 | 775.1 | 794.2 | 797.1 |
| RI @ 589.3 nm | | 1.491 | 1.491 | 1.495 | 1.493 | 1.492 | 1.496 | 1.494 | 1.494 |
| SOC (nm/mm/MPa) | | 3.472 | 3.489 | 3.334 | 3.413 | 3.475 | 3.3 | 3.346 | 3.41 |
| Poisson's Ratio | | 0.199 | 0.199 | 0.201 | 0.204 | 0.206 | 0.201 | 0.202 | 0.206 |
| shear modulus (GPa) | | 28.5 | 28.5 | 29.2 | 28.5 | 27.8 | 29.5 | 28.8 | 28.2 |
| Young's modulus (GPa) | | 68.3 | 68.3 | 70.1 | 68.5 | 67.0 | 70.9 | 69.4 | 68.0 |
| VFT | A | −1.418 | −1.312 | −1.288 | −1.707 | −2.292 | −1.226 | −1.455 | −1.958 |
| parameters | B | 6008.9 | 5720.6 | 5228.5 | 6526.4 | 7890.1 | 5052.2 | 5795.5 | 7141.4 |
| | T₀ | 110.5 | 133.6 | 173.9 | 62.0 | −18.9 | 184.7 | 119.3 | 20.4 |

| | | | | | | | | |
|---|---|---|---|---|---|---|---|---|
| 200 P temp (° C.) | 1726 | 1717 | 1631 | 1690 | 1699 | 1617 | 1662 | 1697 |
| 35000 P temp (° C.) | 1118 | 1110 | 1070 | 1106 | 1135 | 1060 | 1085 | 1119 |
| 100000 P temp (° C.) | 1047 | 1040 | 1005 | 1035 | 1063 | 996 | 1017 | 1047 |
| 200000 P temp (° C.) | 1005 | 999 | 967 | 993 | 1020 | 959 | 977 | 1004 |
| Liquidus Temp (° C.) | 960 | 875 | <805 | 795 | 840 | <790 | 830 | 825 |
| Liquidus viscosity | 452 | 2,535 | >9,925 | 15,728 | 7,839 | >13,201 | 1,038 | 8,274 |
| (Kilo poise) | | | | | | | | |

| wt. % | | E17 | E18 | E19 |
|---|---|---|---|---|
| SiO₂ | | 64.54 | 65.14 | 64.20 |
| Al₂O₃ | | 14.87 | 14.14 | 14.92 |
| B₂O₃ | | 9.50 | 9.60 | 9.43 |
| Na₂O | | 8.64 | 8.66 | 9.03 |
| K₂O | | 1.46 | 1.45 | 1.41 |
| MgO | | 0.03 | 0.03 | 0.03 |
| CaO | | 0.96 | 0.97 | 0.98 |
| SnO₂ | | 0.00 | 0.00 | 0.00 |
| density (g/cm³) | | 2.338 | 2.341 | 2.348 |
| CTE (×10⁻⁷) | | 63.7 | 63.6 | 67.4 |
| Strain Point (° C.) | | 538 | 537 | 533.1 |
| annealing Point (° C.) | | 585 | 583 | 580.1 |
| softening Point (° C.) | | 835.1 | 821.7 | 819.9 |
| RI @ 589.3 nm | | 1.491 | 1.491 | 1.492 |
| SOC (nm/mm/MPa) | | 3.561 | 3.51 | 3.485 |
| Poisson's Ratio | | 0.208 | 0.206 | 0.207 |
| shear modulus (GPa) | | 27.0 | 27.3 | 27.3 |
| Young's modulus (GPa) | | 65.1 | 65.9 | 66.0 |
| VFT | A | −3.942 | −2.885 | −2.891 |
| parameters | B | 12586.7 | 9467.0 | 9449.1 |
| | T₀ | −292.8 | −117.6 | −107.9 |

| | | | |
|---|---|---|---|
| 200 P temp (° C.) | 1723 | 1708 | 1712 |
| 35000 P temp (° C.) | 1190 | 1157 | 1163 |
| 100000 P temp (° C.) | 1115 | 1083 | 1090 |
| 200000 P temp (° C.) | 1069 | 1039 | 1046 |
| Liquidus Temp (° C.) | <880 | <880 | <865 |
| Liquidus viscosity | >6,618 | >4,025 | >6,627 |
| (Kilo poise) | | | |

### Example 2

This example demonstrates ion exchange (IOX) of the glasses of Table 3 that were produced from a combination of glass cullet and raw materials.

The glasses in Table 3 were ion-exchanged at the time and temperature indicated in Table 3 in a single-step IOX using 100% KNO₃, though multiple steps and/or mixed molten salt baths are also contemplated. Maximum compressive stress (CS) P and depth of layer (DOL) were analyzed by a surface stress meter using commercially available instruments such as the FSM-6000, manufactured by Orihara Industrial Co., Ltd. (Japan). The results are reported in Table 4. All CS values in Table 4 can have a variation of +25 MPa and DOL variation can be ±0.2 μm due to precision limitations of the metrology. All the glasses used for IOX are 1 mm thick. The fictive temperatures of the glasses in Table 4 were reset to their corresponding 1011 poise temperature to simulate the fictive temperatures that would be made from fusion draw.

TABLE 4
CS and DOL for the Glasses of Table 3 Ion Exchanged at the Indicated Times and Temperatures

| Duration | Temp. | | | | | | | | | |
|---|---|---|---|---|---|---|---|---|---|---|
| (hour) | (° C.) | | E1 | E2 | E3 | E4 | E5 | E6 | E7 | E8 |
| 0.5 | 430 | CS | | | | 494 | 472 | 432 | 440 | 434 |
| | | (MPa) | | | | | | | | |
| | | DOL | | | | 9 | 9 | 11 | 11 | 9 |
| | | (μm) | | | | | | | | |
| 0.75 | 430 | CS | | | | 487 | 461 | 430 | 418 | 428 |
| | | (MPa) | | | | | | | | |
| | | DOL | | | | 10 | 11 | 12 | 13 | 11 |
| | | (μm) | | | | | | | | |
| 1 | 430 | CS | 348 | 341 | 350 | 486 | 452 | 425 | 412 | 417 |
| | | (MPa) | | | | | | | | |
| | | DOL | 10 | 12 | 15 | 11 | 13 | 15 | 15 | 14 |
| | | (μm) | | | | | | | | |
| 2 | 430 | CS | 326 | 341 | 337 | 469 | 442 | 414 | 408 | 408 |
| | | (MPa) | | | | | | | | |
| | | DOL | 15 | 17 | 20 | 16 | 17 | 20 | 21 | 19 |
| | | (μm) | | | | | | | | |
| 4 | 430 | CS | 322 | 329 | 328 | 452 | 430 | 397 | 390 | 396 |
| | | (MPa) | | | | | | | | |
| | | DOL | 21 | 24 | 27 | 22 | 25 | 27 | 29 | 25 |
| | | (μm) | | | | | | | | |
| 9 | 430 | CS | 308 | 300 | 300 | | | | | |
| | | (MPa) | | | | | | | | |
| | | DOL | 28 | 33 | 39 | | | | | |
| | | (μm) | | | | | | | | |
| Duration | Temp. | | | | | | | | | |
| (hour) | (° C.) | | E9 | E10 | E11 | E12 | E13 | E14 | E15 | E16 |
| 0.5 | 430 | CS | 450 | 447 | 542 | 553 | 518 | 536 | 578 | 563 |
| | | (MPa) | | | | | | | | |
| | | DOL | 9 | 9 | 8 | 9 | 11 | 8 | 8 | 10 |
| | | (μm) | | | | | | | | |
| 0.75 | 430 | CS | 447 | 447 | 558 | 584 | 502 | 536 | 565 | 539 |
| | | (MPa) | | | | | | | | |
| | | DOL | 11 | 12 | 12 | 10 | 10 | 13 | 10 | 9 |
| | | (μm) | | | | | | | | |
| 1 | 430 | CS | 444 | 432 | 542 | 555 | 509 | 509 | 599 | 537 |
| | | (MPa) | | | | | | | | |
| | | DOL | 14 | 14 | 11 | 12 | 15 | 12 | 11 | 14 |
| | | (μm) | | | | | | | | |
| 2 | 430 | CS | 426 | 429 | 515 | 499 | 492 | 507 | 529 | 520 |
| | | (MPa) | | | | | | | | |
| | | DOL | 19 | 18 | 16 | 19 | 21 | 16 | 18 | 21 |
| | | (μm) | | | | | | | | |
| 4 | 430 | CS | 411 | 412 | | | | | | |
| | | (MPa) | | | | | | | | |
| | | DOL | 25 | 25 | | | | | | |
| | | (μm) | | | | | | | | |

| Duration | Temp. | | | | |
|---|---|---|---|---|---|
| (hour) | (° C.) | | E17 | E18 | E19 |
| 0.5 | 450 | CS | 495 | 500 | 550 |
| | | (MPa) | | | |
| | | DOL | 15 | 14 | 8.6 |
| | | (μm) | | | |
| 0.75 | 450 | CS | 485 | 490 | 550 |
| | | (MPa) | | | |
| | | DOL | 17 | 17 | 10 |
| | | (μm) | | | |
| 1 | 450 | CS | 482 | 480 | 535 |
| | | (MPa) | | | |
| | | DOL | 20 | 19 | 12 |
| | | (μm) | | | |

### Example 3

This example demonstrates the effect of Na₂O and the weight ratio Na₂O/Al₂O₃ on the glass viscosity, maximum compressive stress (CS), and depth of layer (DOL).

Both Na₂O and the weight ratio Na₂O/Al₂O₃ impacts glass viscosity, which is important to glass forming processes as well as the ion exchange profile.

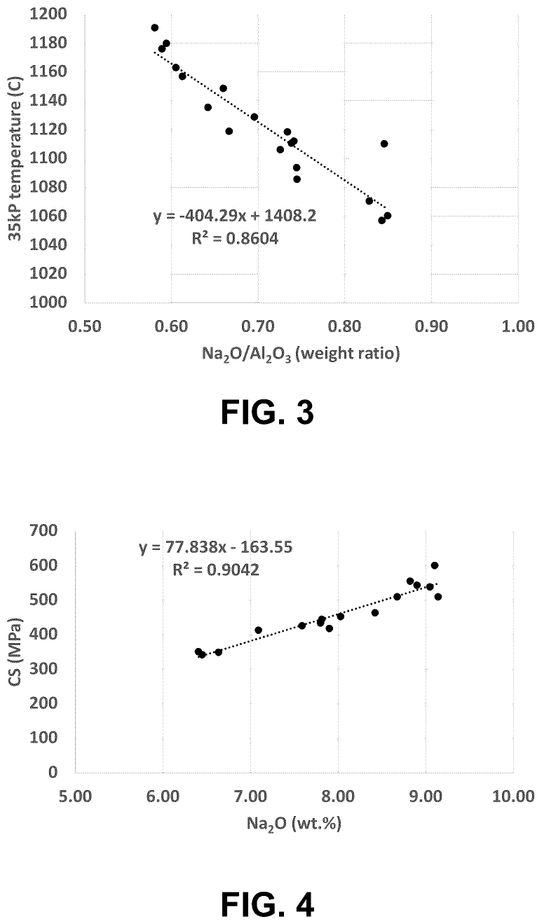

The 35 kP temperature and Na₂O/Al₂O₃ weight ratio for the glasses in Table 3 were plotted, and the results set forth in FIG. 3. As can be seen in FIG. 3, the Na₂O/Al₂O₃ weight ratio affects the 35 kP temperature in a near linear relationship. As the Na₂O/Al₂O₃ ratio becomes higher, the 35 kP temperature is decreasing. Because both Na₂CO₃ and Al₂O₃ are being added as raw materials to the glass cullet herein to make new glasses, it is preferred that the resulting compositions prior to IOX have weight ratio of Na₂O/Al₂O₃<1. Moreover, it is preferred that the 35 kP temperature is above 1000° C. in fusion forming processes, and various glasses disclosed herein meet this requirement, as shown in FIG. 3.

The maximum compressive stress (CS) and Na₂O amount for the glasses in Tables 3 and 4 were plotted using the data for the 1 hour IOX time period conducted at 430° C., and the results set forth in FIG. 4. As can be seen from FIG. 4, the Na₂O amount affects the 35 kP temperature in a near linear relationship. In particular, as the Na₂O concentration is decreased, the CS also decreases. In some aspects, therefore, to reach >300 MPa CS within one hour during IOX, it may be desirable to keep Na₂O>6 wt. % in the glass that is to be ion-exchanged.

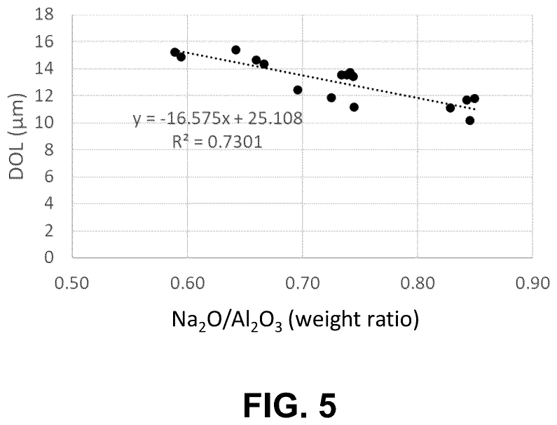

The depth of layer (DOL) and Na₂O/Al₂O₃ weight ratio for the glasses in Tables 3 and 4 were plotted using the data for the 1 hour IOX time period conducted at 430° C., and the results set forth in FIG. 5. As can be seen from FIG. 5, the Na₂O/Al₂O₃ weight ratio affects the DOL in a near linear relationship. In particular, as the Na₂O/Al₂O₃ weight ratio is increased, the DOL decreases. In some aspects, therefore, to reach a DOL of at least 8 μm within one hour during IOX, it may be desirable to keep Na₂O/Al₂O_{3<0.9} in the final glass that is to be ion-exchanged.

As demonstrated in the examples herein, in some aspects, glasses can be made from adding sodium carbonate, alumina, silicon oxide, or any combination thereof to glass cullet, melted, and formed into a new glass that therefore included recycled glass (glass cullet) as a component. The concentration of glass cullet may be at least 60 wt. %, such as at least 80 wt %, relative to the total weight of glass cullet and raw materials. In some aspects, sodium carbonate is added to provide Na₂O in the final glass article to enable chemical strengthening by ion-exchange method. In some aspects, Al₂O₃, in conjunction with alkali metal oxides present in the glass compositions such as Na₂O, or the like, improves the susceptibility of the glass to ion exchange strengthening. In some aspects, SiO₂ is added to increase viscosity of glass, such that the glass can be made using a fusion platform.

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising.” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top.” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Unless otherwise specified, all compositions are expressed in terms of as-batched weight percent (wt. %). As will be understood by those having ordinary skill in the art, various melt constituents (e.g., silicon, alkali- or alkaline-based, boron, etc.) may be subject to different levels of volatilization (e.g., as a function of vapor pressure, melt time and/or melt temperature) during melting of the constituents. As such, the as-batched weight percent values used in relation to such constituents are intended to encompass values within +0.5 wt. % of these constituents in final, as-melted articles. With the forgoing in mind, substantial compositional equivalence between final articles and as-batched compositions is expected.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A glass, comprising:
SiO₂ in an amount of 64-73 wt. %;
Al₂O₃ in an amount of 7-15 wt. %;
B₂O₃ in an amount of 9-11 wt. %;
Na₂O in an amount of 6-9.5 wt. %;
K₂O in an amount of 0.5-3 wt. %; and
CaO in an amount of at least 0.05 wt. %;
Li₂O in an amount of 0.1 wt. % or less;
wherein a weight ratio of Na₂O/Al₂O₃ is less than or equal to 0.9.

2. The glass of claim 1, comprising:
SiO₂ in an amount of 66-72 wt. %;
Al₂O₃ in an amount of 8-14 wt. %;
Na₂O in an amount of 6.5-9 wt. %;
K₂O in an amount of 1-2.5 wt. %; and
CaO in an amount of 0.1-5 wt. %;

3. The glass of claim 1, comprising:
CaO in an amount of 0.1-2 wt. % MgO in an amount of 0-1 wt. %; and
SnO₂ in an amount of 0-1 wt. %.

4. The glass of claim 1, comprising at least one of:
a coefficient of thermal expansion (CTE) of 70×10⁻⁷/° C. or less; and
a liquidus viscosity of at least 150 kP.

5. The glass of claim 1, wherein the Young's modulus is at least 60 GPa.

6. The glass of claim 1, wherein the CTE is at least 44×10⁻⁷/° C.

7. The glass of claim 1, comprising a 200 P temperature of 1800° C. or less.

8. The glass of claim 1, comprising a 35,000 P temperature of at least 1000° C.

9. The glass of claim 1, comprising a strain point of at least 525° C.

10. The glass of claim 1, comprising a liquidus temperature of 1000° C. or less.

11. The glass of claim 1, comprising a liquidus viscosity of 18,000 kP or less.

12. The glass of claim 1, wherein, when the glass has a thickness of 1 mm and is subjected to a single step ion exchange in a 100 wt. % KNO₃ molten salt bath at 430-450° C., the glass achieves a maximum compressive stress of 300-600 MPa and a depth of layer (DOL) of at least 8 μm within 1 hour.

13. The glass of claim 1, wherein the glass is substantially free of Li₂O.

14. A method of chemically strengthening a glass-based substrate, the method comprising:
ion exchanging the glass-based substrate in a molten salt bath to form a glass-based article;
wherein the glass-based article comprises:
a maximum compressive stress (CS) of 300-600 MPa; and
a depth of layer (DOL) of 5-30 μm;
wherein the glass-based substrate comprises the glass of claim 1.

15. The method of claim 14, wherein the ion-exchanging takes place for 2 hours or less.

16. The method of claim 14, wherein the molten salt bath comprises at least 95 wt. % KNO₃ and a temperature of at least 400° C.

17. A glass-based article, comprising:
a maximum compressive stress (CS) of 300-600 MPa;
a depth of layer (DOL) of 5-30 μm; and
a composition at a center of the glass-based article;
wherein the composition at the center of the glass-based article comprises the glass of claim 1.

18. A consumer electronic device comprising:
a housing having a front surface, a back surface, and side surface;
electrical components provided at least partially within the housing, the electrical components including at least a controller, a memory, and a display, the display being provided at or adjacent to a front surface of the housing; and
a cover glass disposed over the display,
wherein at least one of a portion of the housing or the cover glass comprises the glass-based article of claim 17.

19. A method of recycling glass, the method comprising:
heating a composition to form a melt, the composition comprising:
glass cullet in an amount of at least 60 wt. %; and
raw materials in an amount of 40 wt. % or less;
based on total weight of the composition;
wherein, when the melt is formed and cooled to form a glass-based substrate, the glass-based substrate is the glass of claim 1.

20. A composition, comprising:
glass cullet in an amount of at least 60 wt. %; and
raw materials in an amount of 40 wt. % or less;
based on total weight of the composition
wherein the glass cullet comprises:
SiO₂ in an amount of 65-80 wt. %;
Al₂O₃ in an amount of 1-10 wt. %;
B₂O₃ in an amount of 5-15 wt. %;
Na₂O in an amount of 1-10 wt. %;
K₂O in an amount of 0.1-5;
CaO in an amount of 0.05-10 wt. %; and
Li₂O in an amount of less than 0.1 wt. %;
based on total weight of glass cullet; and
wherein the raw materials comprise at least one of:
SiO₂;
Na₂CO₃; and
Al₂O₃.
